(19) United States
(12) Patent Application Publication
(10) Pub. No.: US 2004/0139858 A1
(43) Pub. Date: Jul. 22, 2004

(54) Filtration media of porous inorganic particles

(75) Inventors: Majid Entezarian, Hudson, WI (US); Thomas M. Fitch, St. Paul, MN (US); Richard Smasal, Afton, MN (US); James R. Johnson, Lady Lake, FL (US)

Correspondence Address: FOLEY AND LARDNER, SUITE 500, 3000 K STREET NW, WASHINGTON, DC, 20007, US

(73) Assignee: PHILLIPS PLASTICS CORPORATION

(21) Appl. No.: 10/690,454

(22) Filed: Oct. 22, 2003

Related U.S. Application Data
(63) Continuation-in-part of application No. 10/363,849, filed on Mar. 14, 2003.
Application No. 10/363,849 is a 371 of international application No. PCT/US02/05753, filed on Feb. 28, 2002.
(63) Continuation of application No. 10/076,144, filed on Feb. 15, 2002, now abandoned.
(63) Continuation-in-part of application No. 10/632,805, filed on Aug. 4, 2003.
(60) Provisional application No. 60/272,044, filed on Mar. 1, 2001.

(51) Int. Cl. B01D 46/32

(52) U.S. Cl. 95/275

(57) ABSTRACT

Inorganic, porous particles attract oleo material within a flow of fluid such as a liquid or gas. The particles can be arranged into a packed bed to filter the oleo material from the fluid flow, which can agglomerate in the pores of the filtering particles. Agglomeration of the filtrate within the pores of the particles does not impede the flow of fluid through the interstices of bed of particle and, hence, enhances the filtering capacity of the particles. Furthermore, the inorganic particles are re-usable, in that they can be subjected to harsh filtrate-separation techniques, e.g., heat treatment, solvent extraction and detergent washing, yet retain their desired properties. Methods of making and using these particles also are described herein. Inorganic, porous particles filter a substance or substances from a flow of fluid such as a gas. The particles can be arranged into a bed to filter a substance (filtrate substance) from a fluid. The filtrate substance can collect on or within the pores of the inorganic particles. Collection of the filtrate substance within the pores of the particles rather than within the interstices of the bed enhances the filtering capacity and does not impede the flow of fluid through the bed of particles. Furthermore, the inorganic particles are re-usable, in that they can be subjected to harsh filtrate-separation techniques, e.g., heat treatment, solvent extraction, detergent washing, and centrifugal separation, yet retain their desired properties. A separation cartridge is disclosed which comprises a first separation medium, a second separation medium, and a frame. The second separation medium is positioned adjacent to the first separation medium. The frame is configured to hold the first and second separation mediums. The separation cartridge is configured to separate one or more entrained substances from a gas stream in a hood system.

### CROSS-REFERENCE TO RELATED PATENT APPLICATIONS

This application is a continuation in part of: (1) U.S. patent application Ser. No. 10/632,805, entitled “Separation Apparatus” (Attorney Docket No. (065640-0210), filed on Aug. 4, 2003, pending, and (2) U.S. patent application Ser. No. 10/363,849, entitled “Filtration Media of Porous Inorganic Particles” (Attorney Docket No. 065640-0190), filed on Mar. 14, 2003, pending, which is the National Stage of International Application No. PCT/US02/05753, entitled “Filtration Media of Porous Inorganic Particles,” filed on Feb. 28, 2002, published in English, which: (1) claims the benefit under 35 U.S.C. § 119(e) of U.S. Provisional Application No. 60/272,044, entitled “Filtration Media of Porous Inorganic Particles,” filed on Mar. 1, 2001, and (2) claims the benefit under 35 U.S.C. § 365(c) of U.S. patent application Ser. No. 10/076,144, entitled “Filtration Media of Porous Inorganic Particles,” filed on Feb. 15, 2002, abandoned, which also claims the benefit of U.S. Provisional Application No. 60/272,044, entitled “Filtration Media of Porous Inorganic Particles,” filed on Mar. 1, 2001, all of which are hereby expressly incorporated by reference in their entireties. Also, Published U.S. patent application No. 2003/0164093, entitled “Two Stage Air Filter,” filed on Mar. 1, 2002, is hereby expressly incorporated by reference in its entirety.

### BACKGROUND

The following material is from U.S. Provisional Application No. 60/272,044, filed on Mar. 1, 2001.

The invention relates generally to filtration media and methods for using the same. More specifically, the invention includes porous, inorganic materials that are capable of filtering one or more oleo substances from a stream of moving fluid, such as air. Yet, the invention also contemplates the manufacture and use of porous, inorganic materials that are capable of filtering one or more hydrophilic substances from a stream of moving fluid, such as air.

Filtration media typically are used to prevent undesirable vapors or suspended droplets in an air stream from escaping into the atmosphere. This is typical in deep fat fryers used in the food preparation industry. For example, whenever an oleo material (e.g. grease or fat) is heated, some will vaporize or form droplets. There is a desire to prevent such vaporized or droplet material from escaping into the air, unfiltered. Presently employed filtering media include an aggregate of fibrous material, such as fiberglass, that extends over traveling path of a vapor or liquid, such that the fibrous material “catches” the oleo vapors or droplets as they pass through the interstices of the filtering material. Although, initially, such filtering mechanisms may be capable of efficiently removing the oleo vapors or droplets from the air stream, the oleo vapors or droplets gather between the interstices of the filtering material in increasing quantities as the filtration process progresses.

Over time, the flow of vapor through the filtering apparatus becomes frustrated. Furthermore, the flow of air through the filter immediately begins to decrease as the oleo material begins to collect on the filter media. This “build-up” of filtrate can completely block the flow of air through the filter, requiring the replacement of the filter. This replacement process typically requires a shut down of the mechanism that produces the vapor. Often times, the filter, upon having the filtrate caked thereon, is disposed of, without further use.

U.S. Pat. No. 5,776,354, issued to van der Meer et al., discloses a method for separating a disperse liquid phase (i.e. an oil film) from a gas, using a filter bed of a particulate, porous polymer material on the order of 0.1 to 10 mm. Although van der Meer et al. teach that the disperse liquid phase can fill into the pores of the particulate material, the particulate material is a polymer, thereby restricting the available methods for subsequently separating the liquid phase from the particulate material. In fact, van der Meer et al. only teach centrifugal force (i.e. a centrifuge) for separating the oil from particulate material. Thus, there remains a need for a filtration medium that (1) not only ameliorates the problem of restricted air flow through the filter, (2) but also can undergo a harsh filtrate-separation process, yet subsequently retain its desired properties for repeated use.

The following material is from U.S. patent application Ser. Nos. 10/076,144 and 10/363,849 and International Application No. PCT/US02/05753 the earliest of which was filed on Feb. 15, 2002.

The invention relates generally to filtration. More specifically, the invention relates to the use of porous inorganic particles in a filtration apparatus, such as a packed bed, where the apparatus includes porous, inorganic particles. The invention also contemplates the use of the porous, inorganic particles, particularly in a packed bed, which are capable of filtering one or more substances from a fluid, such as air.

Filtration media can be used to prevent undesirable vapors, particulate, or suspended droplets in a gas stream from escaping into the atmosphere. For example, whenever an oleo material or substances (e.g. grease, oil or fat) are heated, some will vaporize or form droplets. There is a desire to prevent such vaporized or droplet material from escaping into the air, unfiltered. Presently employed filtering media can include an aggregate of fibrous material, such as organic fiber mat or inorganic fiberglass, that extend over the traveling path of a vapor or liquid, such that the fibrous material catches the oleo vapors or droplets as they pass through the interstices of the filtering material. Although, initially, such filtering mechanisms may be capable of efficiently removing the oleo vapors or droplets from the air stream, the oleo vapors or droplets gather in the interstices of the filtering material in increasing quantities as the filtration process progresses, resisting the flow.

The flow rate of air through the filter immediately begins to decrease as the oleo material begins to collect on the filter media. This build-up of undesirable substances can substantially or completely block the flow of air and its load of material to be filtered through the filter, requiring frequent replacement of the filter. This replacement process typically requires a shut down of the mechanism that produces the vapor. Often times, the filter, upon having the undesirable substance collected thereon is disposed of without further use.

U.S. Pat. No.5,776,354, issued to van der Meer et al., discloses a method for separating a dispersed liquid phase (i.e. an oil film) from a gas, using a filter bed of a particulate, porous polymer material whose size is on the order of 0.1 to 10 mm. Although van der Meer et al. teach that the dispersed liquid phase can fill into the pores of the particulate material, the particulate material is a polymer, thereby restricting the available methods for subsequently separating the liquid phase from the particulate material. In fact, van der Meer et al. only teach centrifugal force (i.e. a centrifuge) for separating the oil from particulate material. Thus, there remains need for filtration media that not only (1) ameliorate the problem of restricted airflow through the filter, but (2) also can undergo harsher filtrate-separation processes, yet subsequently retain its desired properties for repeated use.

The following material is from U.S. patent application Ser. No. 10/632,805, filed on Aug. 4, 2003.

The present disclosure relates generally to the field of separation apparatuses, and, more particularly, to the field of separation apparatuses for a hood.

Cooking foods containing oily substances causes the emission of aerosols and vapors that include substances such as grease, soot, etc. that may coat kitchen hoods and ductwork meant to channel them away from the kitchen environment. Grease that is not deposited on the ductwork is carried to the exterior of a building where it creates further problems. For example, grease buildup on the exterior of a building may cause the building to decay at a faster rate (e.g., grease buildup on a rubber membrane roof) and adversely affect the appearance of the building. Grease deposited at the outlet of the exhaust/duct system may also act as a source of fuel for a fire or as a slippery coating on walkways. To minimize these problems, kitchen hoods have been designed to carry, capture, and contain grease.

Conventional kitchen hoods use a baffle or mesh filter in the hood or ductwork to capture the effluent grease particles. A baffle generally operates by deflecting the exhaust stream as it passes through the baffle so that heavier substances (e.g. liquids such as grease, solids, etc.) impact the surface of the baffle. After impacting the surface of the baffle, these substances drain to a collection area. A mesh filter typically uses fibers or metal scrim to capture the grease in the between the fiber and scrim.

Unfortunately, these conventional filters suffer from a number of deficiencies. These filters generally capture only larger substances and have limited efficiency. Because more of the substances make it through these filters and are deposited inside the ductwork or outside the building, these areas must be cleaned more often, which often entails considerable additional expense. Also, in some instances, conventional filters such as mesh filters need frequent cleaning and/or replacement.

Accordingly, it would be advantageous to provide a more efficient and complete collection system. In providing such a system, it would also be advantageous for the new system to be used in new installations as well as in retrofitting existing installations where space may be limited and it would otherwise be difficult and/or costly to replace the exhaust system.

Accordingly, it is desirable to provide a separation apparatus that provides one or more of these or other advantageous features. Other features and advantages will be made apparent from the present description. The teachings disclosed extend to those embodiments that fall within the scope of the appended claims, regardless of whether they provide one or more of the aforementioned advantages.

### SUMMARY

The following material is from U.S. Provisional Application No. 60/272,044, filed on Mar. 1, 2001.

Accordingly, it is an object of the invention to provide a renewable filtering media to separate an oleo substance (vaporized or in the form of droplets) from a fluid such as a gas or liquid, without substantially impeding the flow of the fluid through the apparatus.

It is a further object of the invention to provide a filtering media that can retain its filtering properties subsequent to undergoing a harsh filtrate-separation protocol.

It is another object of the invention to provide a filtering system that permits a continuous, uninterrupted fluid flow containing the oleo vapors or droplets from a source that generates the vapors or droplets.

These and other objects will be apparent to a skilled worker, as shown by the embodiments described and contemplated herein.

In a compositional sense, the invention provides a filtration medium that comprises a packed bed of inorganic, porous particles arranged-to separate one or more oleo substances from a moving fluids wherein the particles attract the oleo substance. In a particularly preferred embodiment, the particles relinquish substantially all of the oleo substances during a separation step and the particles maintain the ability to attract the oleo substance thereafter.

The invention further contemplates a system for substantially separating one or more oleo substances from a moving fluid, which comprises the filtration media as described above, in operation with a first duct positioned in relationship with the packed bed of porous particles, such that the moving fluid passes through the duct before passing through the filtration media. The system additionally may comprise a housing for holding the oleo substance in a liquid or solid state, wherein upon heating the housing, the oleo substance vaporizes or forms droplets, and wherein the housing is positioned such that substantially all of the vapor enters the first duct.

In a methodological sense, the invention describes a method for substantially separating one or more oleo substances from a fluid, which comprises the steps of placing a composition of inorganic, porous particles, which may be pellet or pellet-like in shape, into contact with the fluid, which moves relative to the particles; and allowing the oleo substance to agglomerate on at least a portion of the inorganic particles as the vapor composition passes at least substantially through the composition of inorganic porous particles. In one sense, the inorganic porous particles are arranged to form a network suitable for filtering the oleo substance from the moving fluid.

Methods according to invention further comprise substantially separating the oleo substance from the inorganic, porous particles and repeating the steps of placing a composition of inorganic, porous particles into contact with the fluid and allowing the oleo substance to agglomerate on at least a portion of the inorganic particles.

In another embodiment, the invention provides a method for substantially separating a hydrophilic substances from a fluid comprising the steps of placing a composition of inorganic, porous particles into contact with the fluid moving relative to the particles; and allowing the hydrophilic substance to agglomerate on at least a portion of the inorganic particles as the vapor composition passes at least substantially through the composition of inorganic porous particles, wherein the porous particles contain hydrophilic surfaces of their pores, and wherein the hydrophilic substance passes through a first filtration apparatus before contacting the porous particles.

The following material is from U.S. patent application Ser. Nos. 10/076,144 and 10/363,849 and International Application No. PCT/US02/05753 the earliest of which was filed on Feb. 15, 2002.

Accordingly, it is an object of the invention to provide renewable, porous filtering media to separate a filtrate substance (in the form of vapor, aerosol, and/or liquid) from a fluid such as a gas or liquid, such that the flow of the fluid through the porous filtering media will not be substantially impeded prior to the time said porous media are filled with said vapor, aerosol, and/or liquid.

It is a further object of the invention to provide filtering media that can retain their filtering properties subsequent to undergoing a harsh filtrate-separation protocol.

It is another object of the invention to provide filtering media that permit a continuous, uninterrupted fluid flow. This provides a uniform filtration mode until the media are saturated.

The invention provides for a filtration media that includes porous particles (whose composition is inorganic) arranged to separate one or more filtrate substances from a fluid or fluids wherein the porous particles collect and retain within themselves the filtrate substance(s). In a preferred embodiment, the porous particles are arranged in a packed bed. In a particularly preferred embodiment, the particles relinquish substantially all of the substances during a separation step and the particles maintain the ability to collect the substance(s) repeatedly.

The invention further contemplates an apparatus for separating one or more substances from a moving fluid which includes a housing for said packed bed of porous particles located in a duct through which said moving fluid with the filtrate substance(s) is passing. Various designs may be used so as to cycle the moving fluid through a plurality of such housings and beds without having to shut down the system. Further, the beds may be treated in said cycles so as to refresh the particles for their intended use.

In a preferred embodiment, the invention describes a method for substantially separating one or more oleo substance(s) from a fluid, particularly a gas such as air, which comprises the steps of placing the inorganic, porous particles, which may be spherical or pellet-like in shape or have other shapes, into contact with the fluid, which moves relative to the particles; and allowing the oleo substance(s) to collect within at least a portion of the inorganic particles as the vapor composition passes at least substantially through the inorganic porous particles. In one sense, the inorganic porous particles are arranged to form a network, such as a packed bed, suitable for filtering the oleo substance(s) from the moving fluid.

Methods according to the invention further comprise substantially separating the filtrate substance from the inorganic, porous particles and repeating the steps of placing the inorganic, porous particles into contact with the fluid and allowing the filtrate substance to collect within at least a portion of the inorganic particles.

In another embodiment, the filtrate substance includes hydrophilic vapors or suspended droplets. This invention provides a method for substantially separating the hydrophilic vapors or suspended droplets by placing the inorganic, porous particles, preferably in the form of a packs d bed, into contact with a fluid flow which contains the filtrate substance. This allows the hydrophilic substance to collect within at least a portion of the inorganic particles due to the hydrophilic nature of internal and external surfaces of the porous particles. Further, the internal surfaces of the pores of said particles may be treated with reactive substances that may be biocidal, catalytic, or chemically reactive with the contents of said vapors or suspended droplets.

These and other objects will be apparent to a skilled worker, as shown by the embodiments described and contemplated herein.

The following material is from U.S. patent application Ser. No.10/632,805, filed on Aug. 4, 2003.

According to one embodiment, a separation cartridge comprises a first separation medium, a second separation medium, and a frame. The second separation medium is positioned adjacent to the first separation medium. The frame is configured to hold the first and second separation mediums. The separation cartridge is configured to separate one or more entrained substances from a gas stream in a hood system.

According to another embodiment, a separation cartridge comprises a separation medium, a packed bed, and a frame. The frame is configured to hold the separation medium and the packed bed. The separation cartridge is configured to separate an entrained substance from a fluid stream.

According to another embodiment, a separation cartridge comprises a plurality of separation mediums and a frame. The frame is configured to hold the plurality of separation mediums. The separation cartridge is configured to separate an entrained substance from a gas stream.

According to another embodiment, a separation apparatus comprises a first plate and a second plate. The first plate comprises entry openings and the second plate comprises exit openings. The second plate is spaced apart from the first plate. The separation apparatus is configured to separate an entrained substance from a gas stream. The entry and exit openings are configured to be offset so that at least a portion of the gas stream passing through the entry openings is deflected before passing through the exit openings.

According to another embodiment, a separation apparatus comprises at least three plates positioned adjacent to one another. Each of the plates comprises openings. The plates are configured to separate an entrained substance from a gas stream in a hood system.

According to another embodiment, a separation system comprises a hood, ductwork coupled to the hood, a fan coupled to the ductwork, and a separation cartridge. The fan is configured to move air including at least one entrained substance from the hood through the ductwork. The separation cartridge is coupled to the hood and/or ductwork and comprises a plurality of separation mediums and a frame configured to hold the separation mediums.

According to another embodiment, a separation system comprises a hood, ductwork coupled to the hood, a fan coupled to the ductwork, and a separation apparatus. The fan is configured to move air from the hood through the ductwork. The separation apparatus is coupled to the hood and/or ductwork and comprises a first plate and a second plate. The first plate comprises entry openings and the second plate comprises exit openings. The second plate is spaced apart from the first plate. The entry and exit openings are configured to be at least substantially offset so that at least a substantial portion of the air passing through the entry openings is deflected before passing through the exit openings.

According to another embodiment, a separation cartridge comprises a first means for separating an entrained substance from a gas using a baffle and/or a mesh filter, a second means for separating an entrained substance from a gas using a packed bed, and a frame configured to hold the first and second means.

### BRIEF DESCRIPTION OF THE DRAWINGS

The following material is from U.S. Provisional Application No. 60/272,044, filed on Mar. 1, 2001.

FIG. 1A shows a filtration system, such as for a deep fat fryer, utilizing a filtration apparatus comprising inorganic particles and a ventilation system according to one embodiment of the present invention.

The following material is from U.S. patent application Ser. Nos. 10/076,144 and 10/363,849 and International Application No. PCT/US02/05753 the earliest of which was filed on Feb. 15, 2002.

FIG. 1B shows a filtration apparatus comprising a packed bed of inorganic particles and a ventilation system according to one embodiment of the present invention.

FIGS. 2A-2D show a filtration apparatus comprising a packed bed of inorganic particles and a ventilation system according to another embodiment of the present invention.

The following material is from U.S. patent application Ser. No. 10/632,805, filed on Aug. 4, 2003.

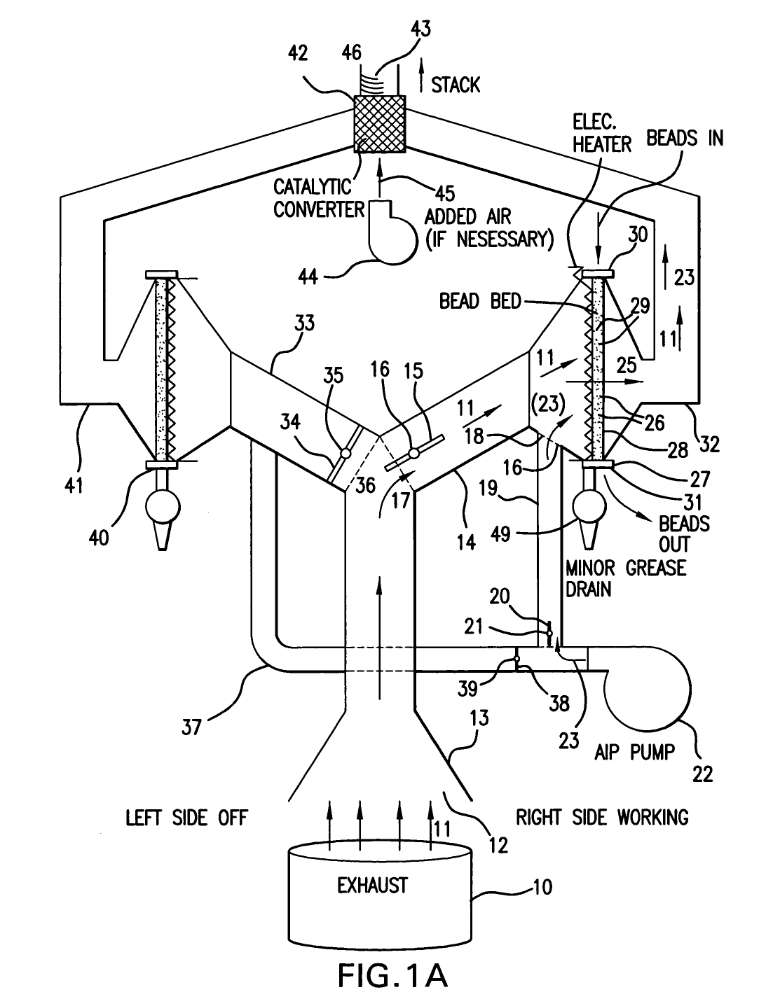

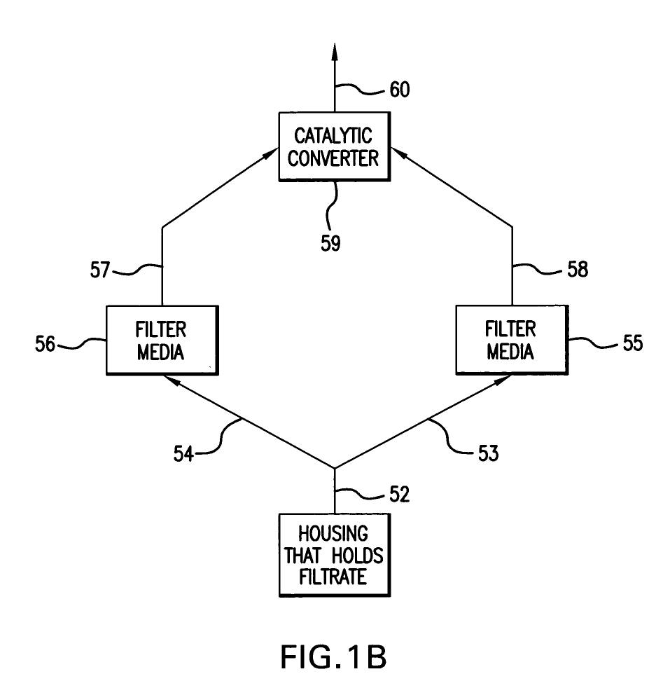

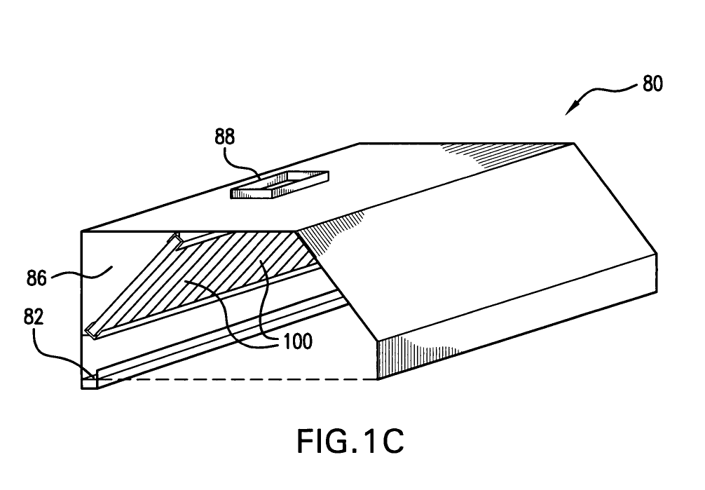

FIG. 1C shows a cross-sectional side perspective view of a hood according to an exemplary embodiment.

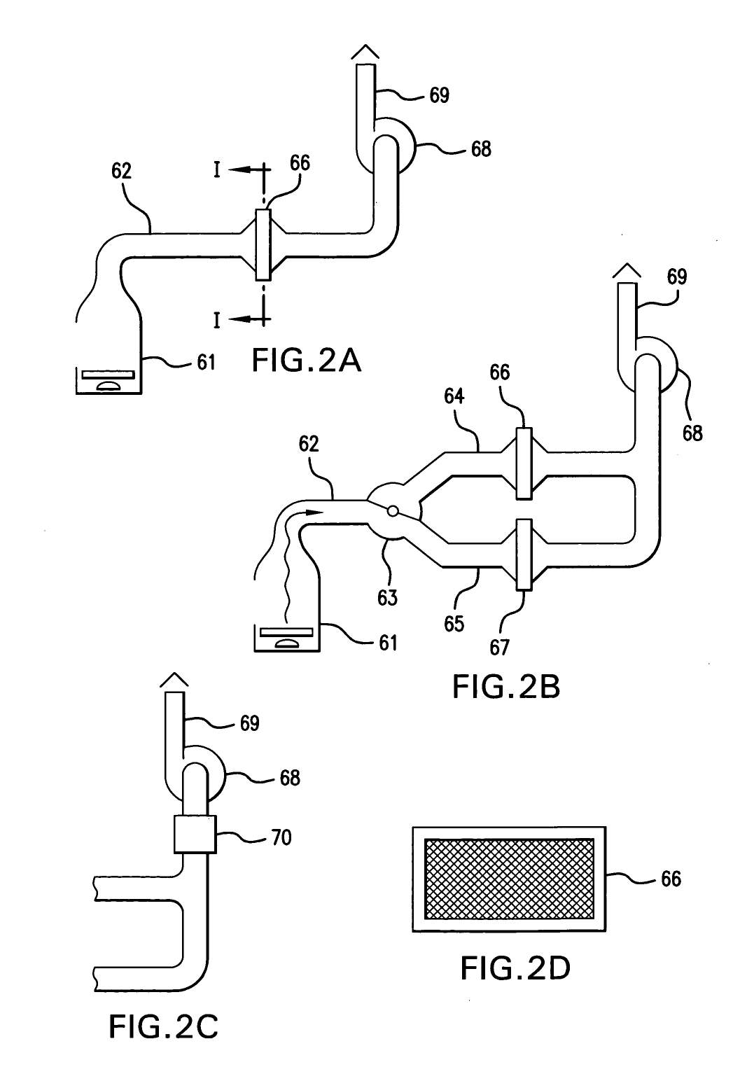

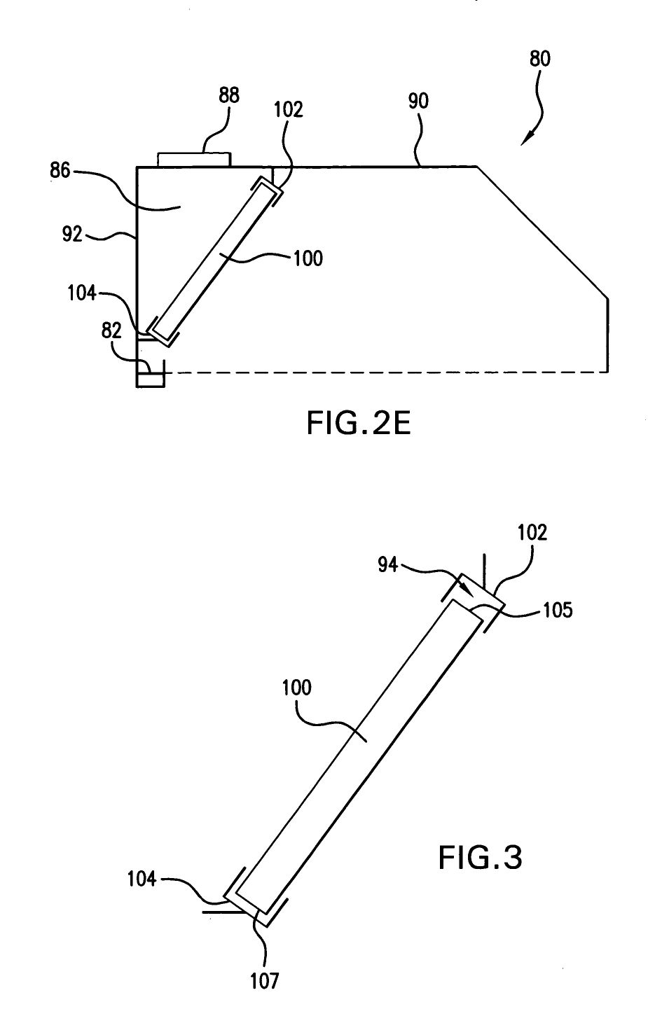

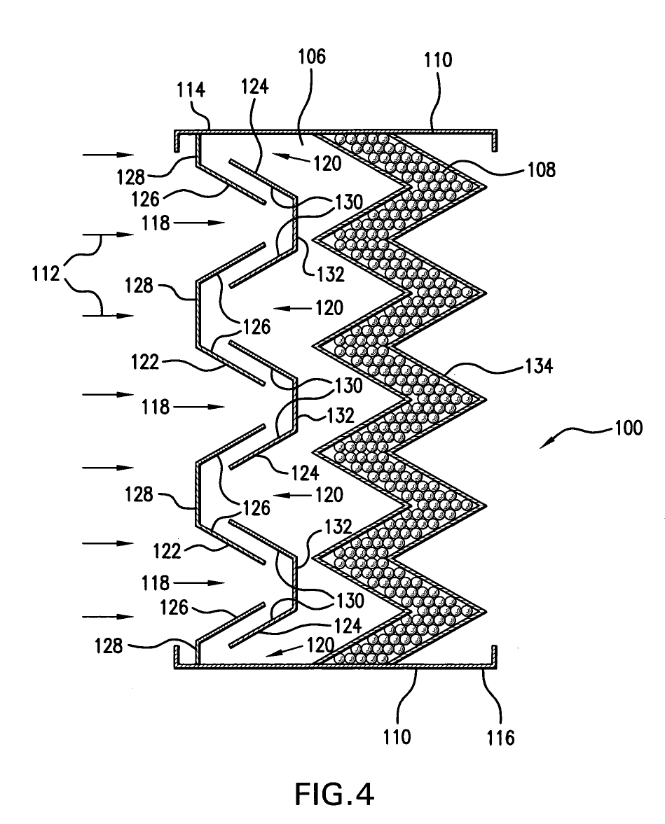

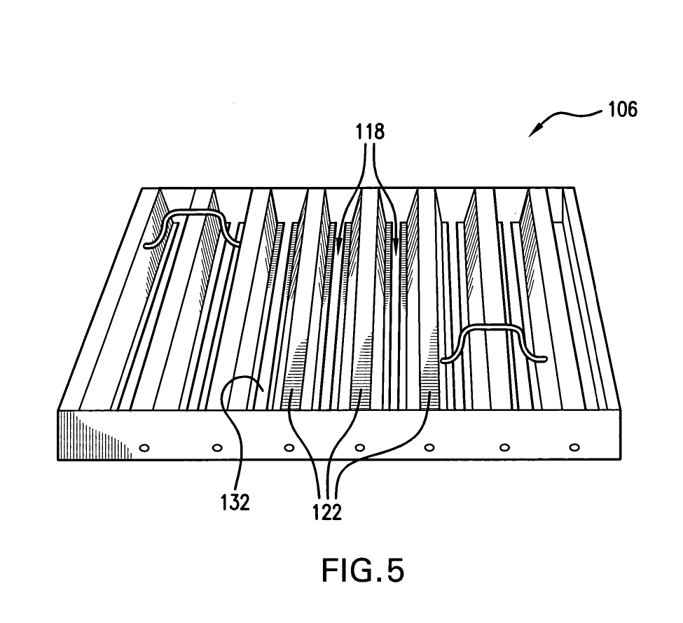

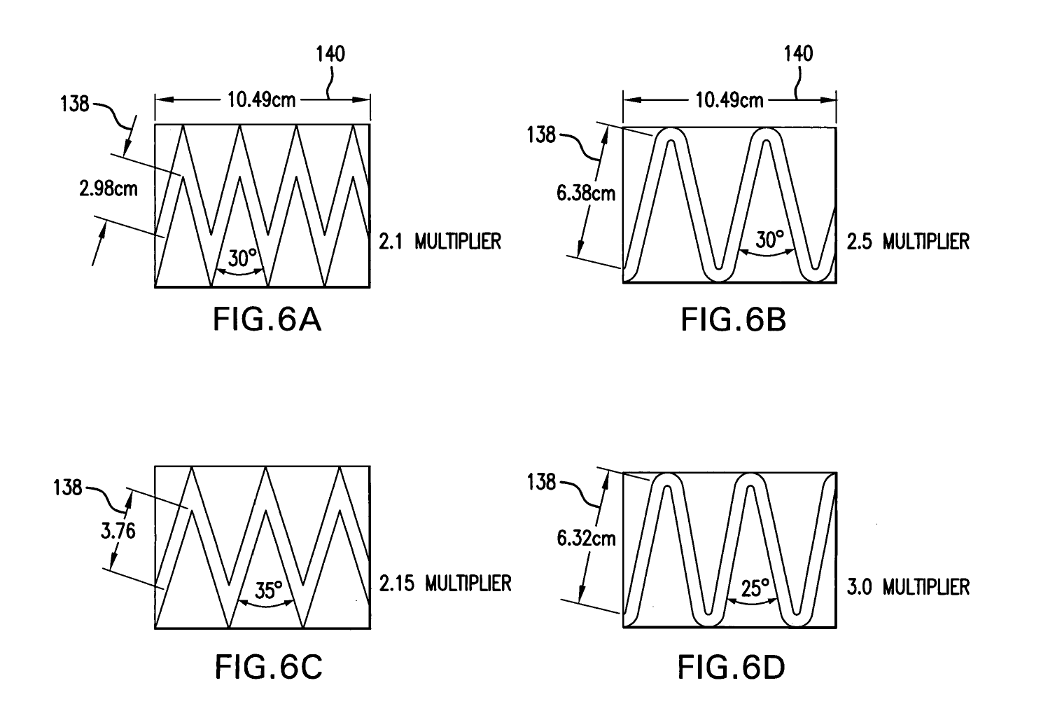

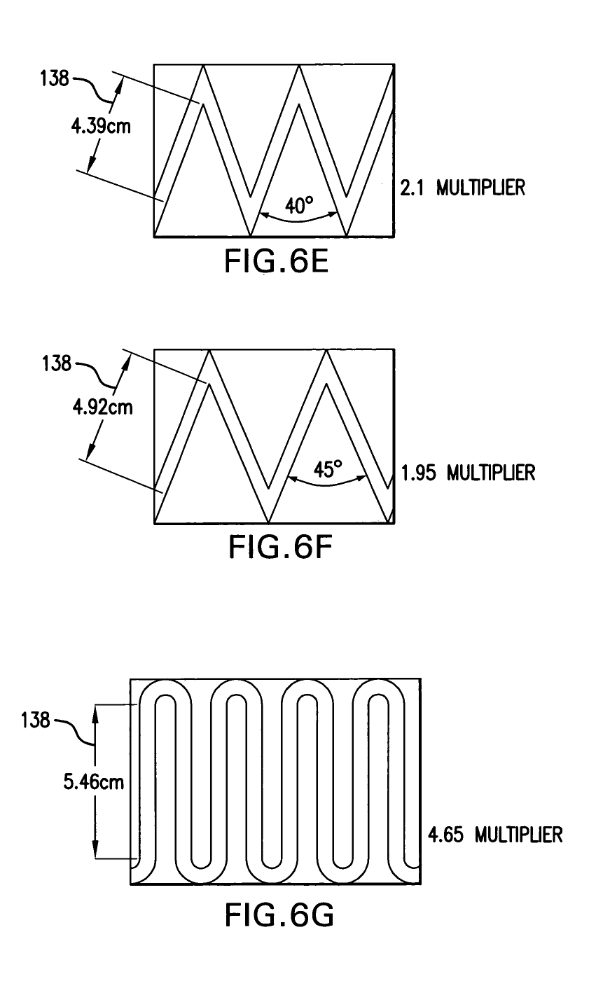

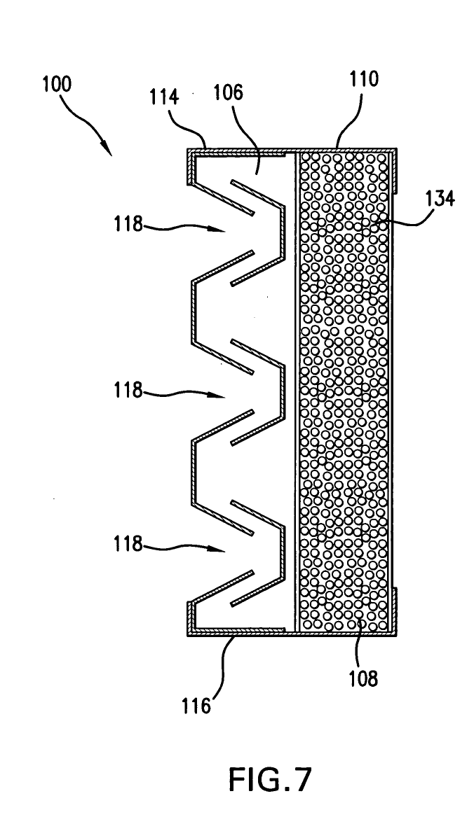

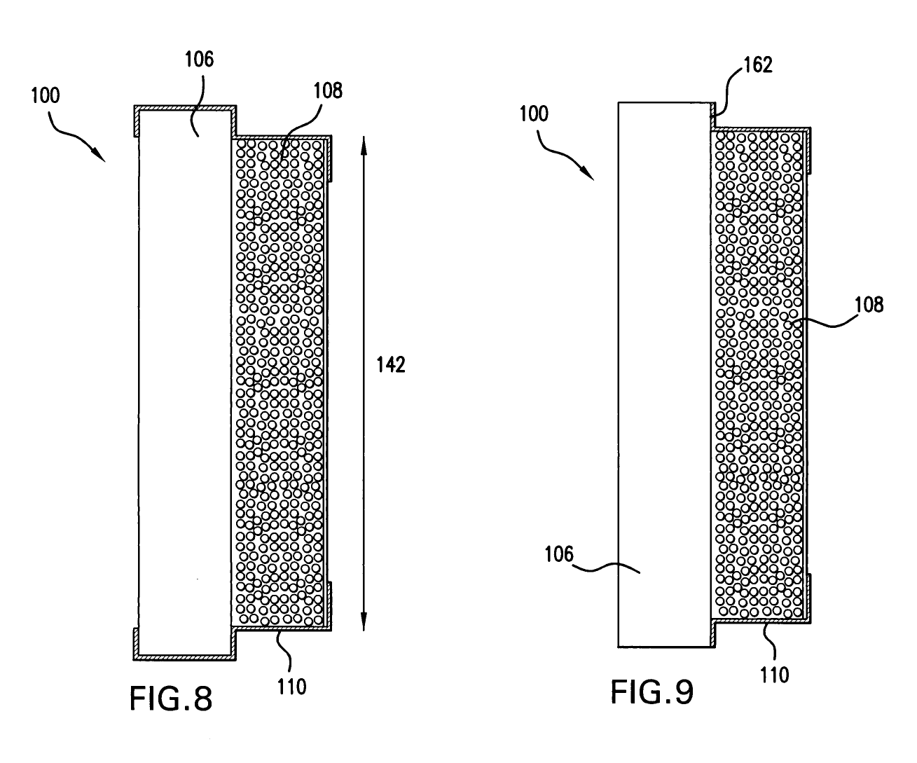

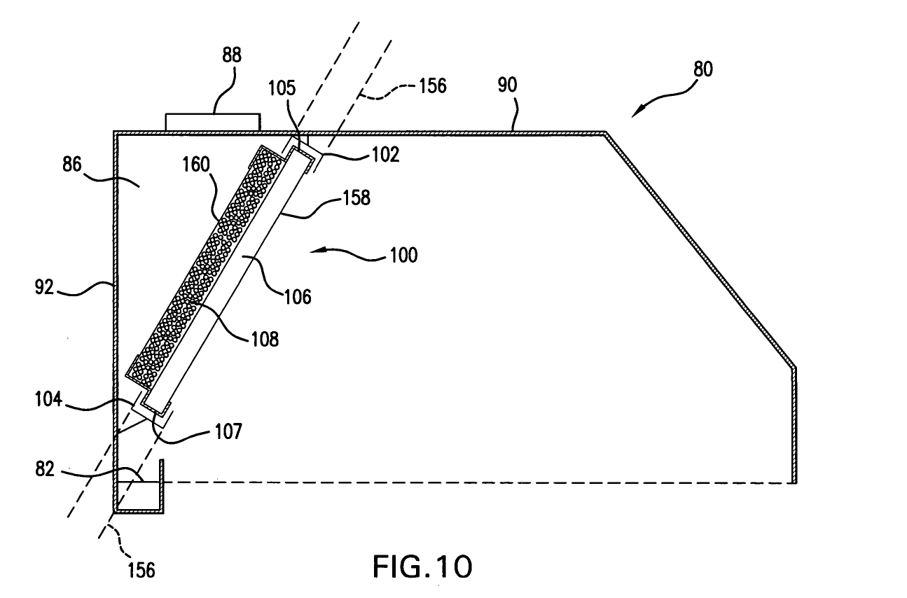

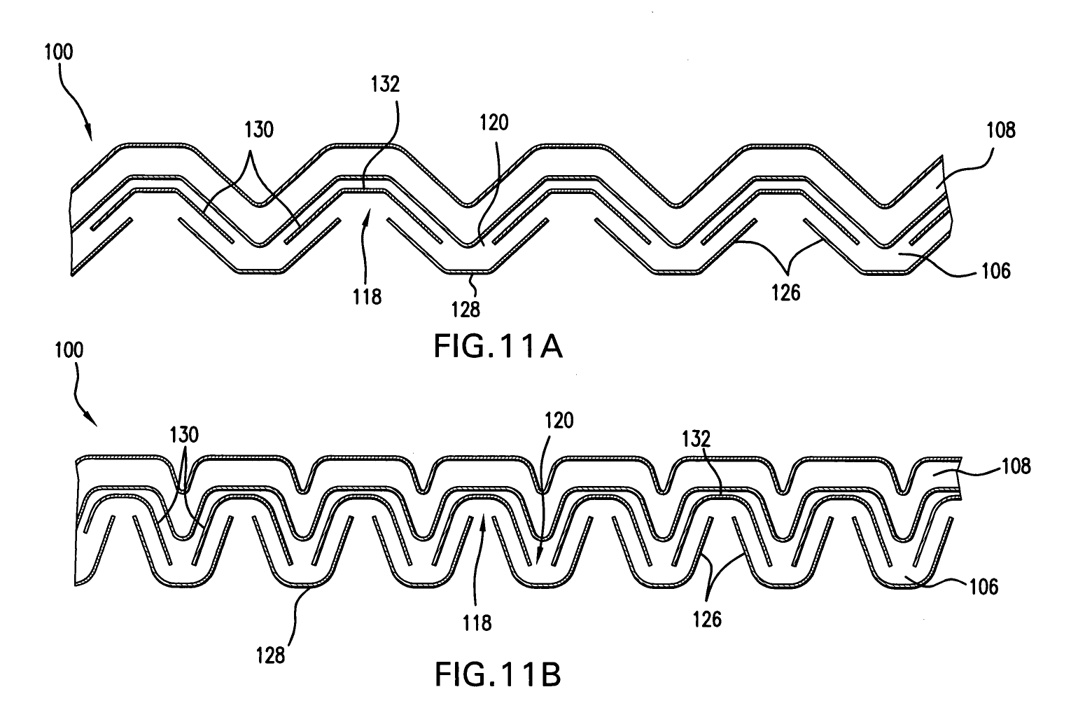

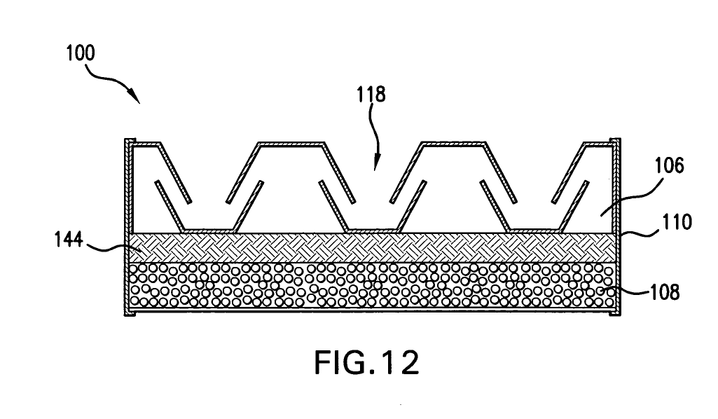

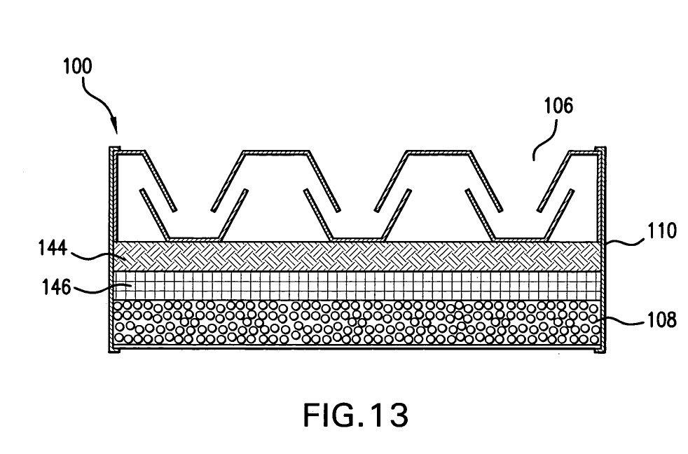

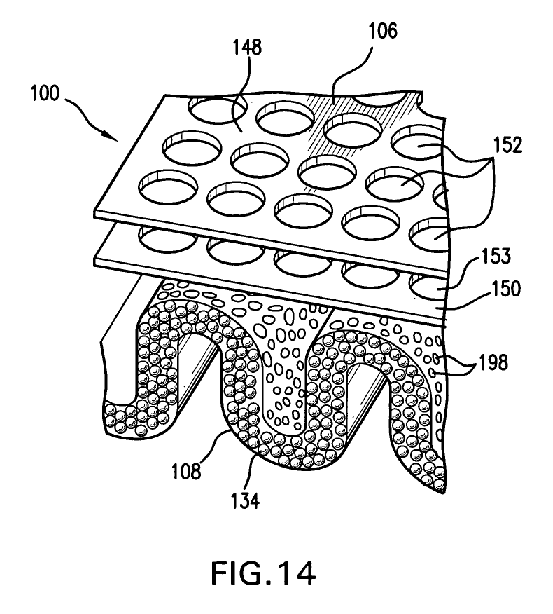

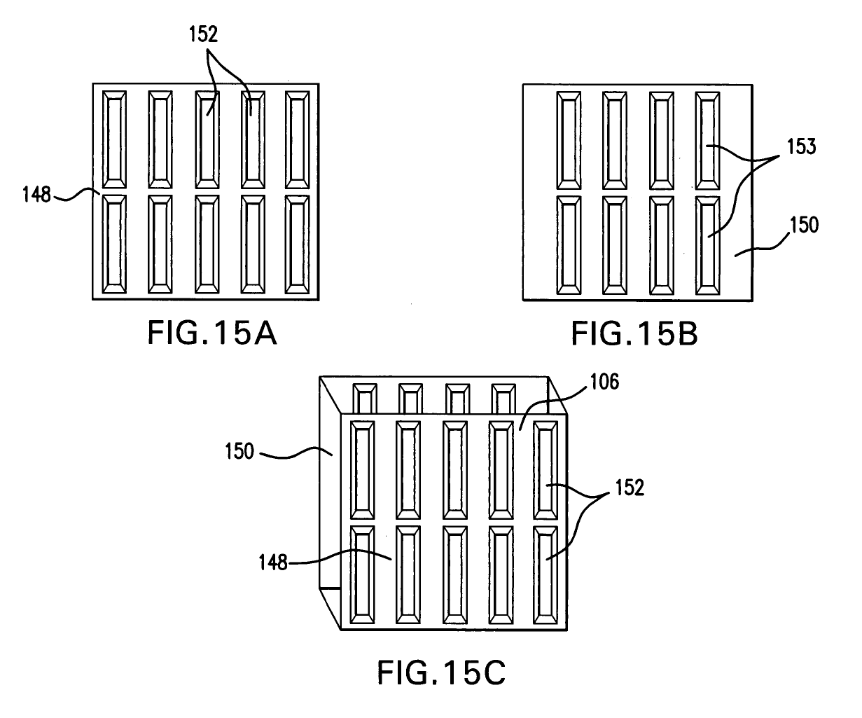

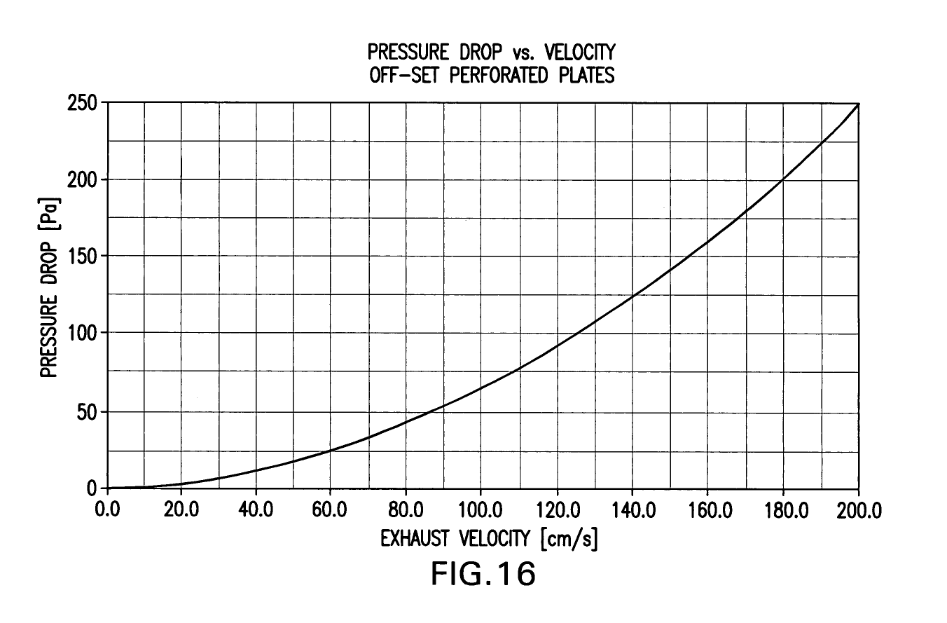

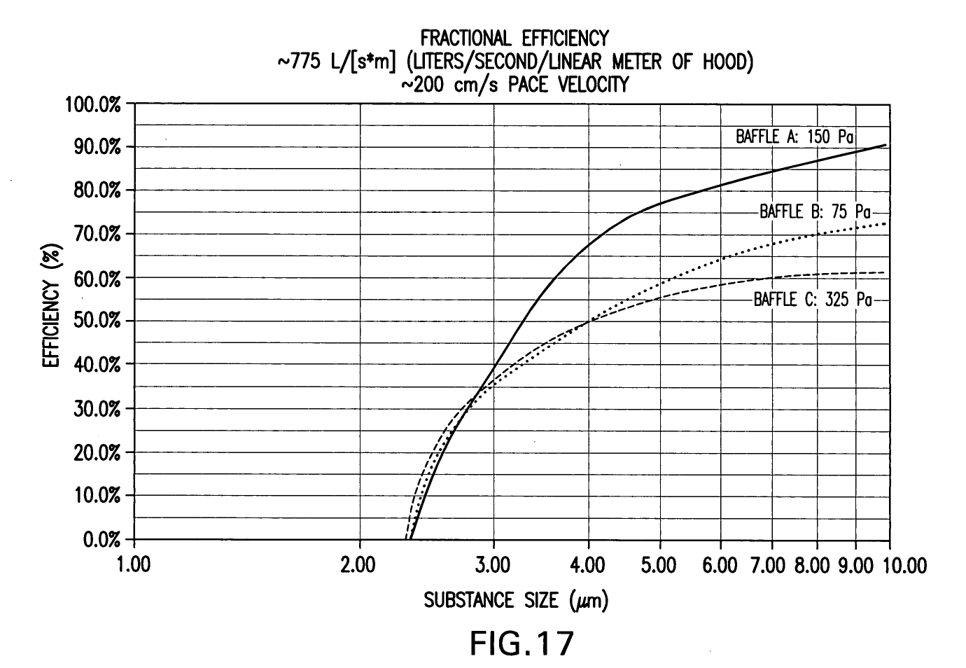

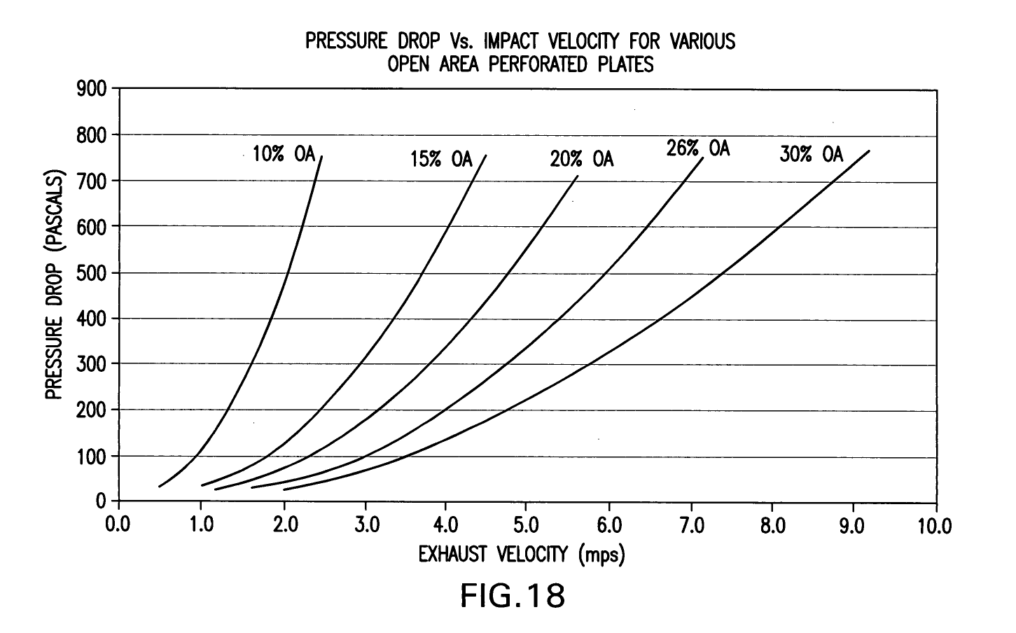

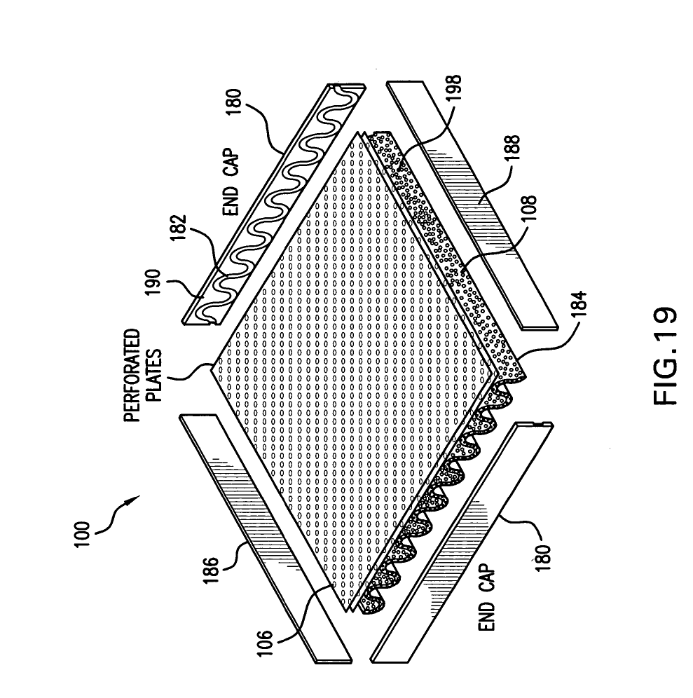

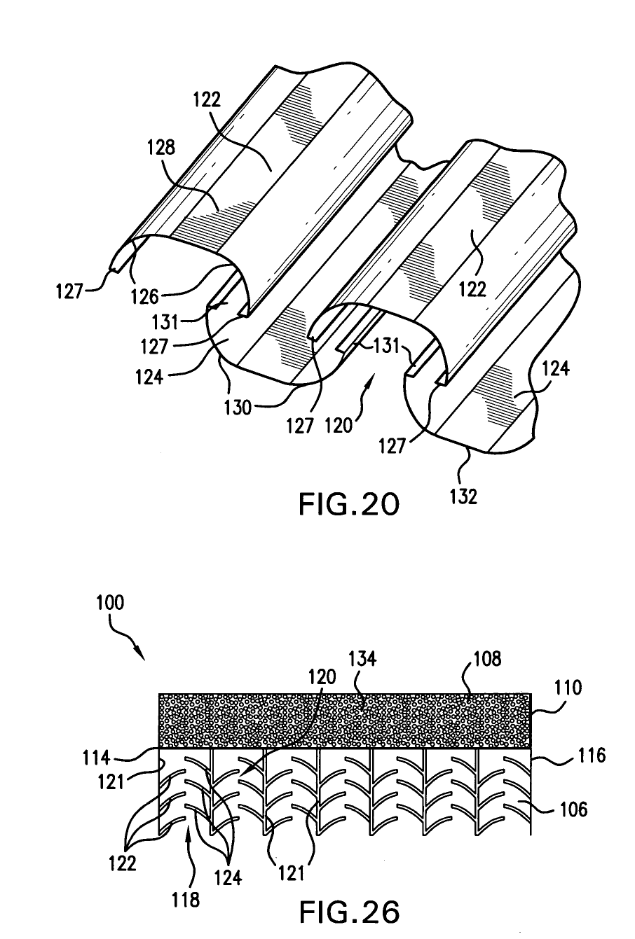

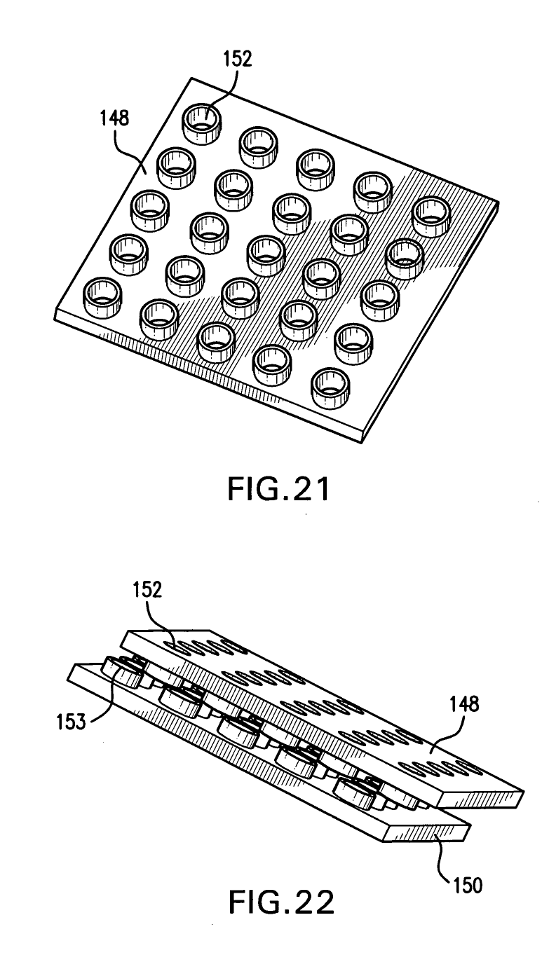

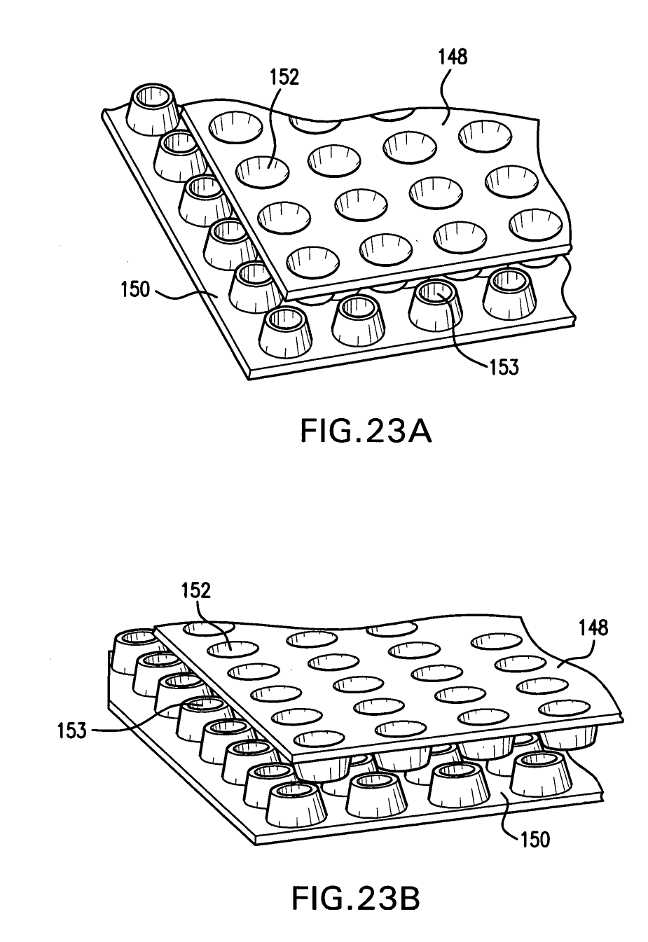

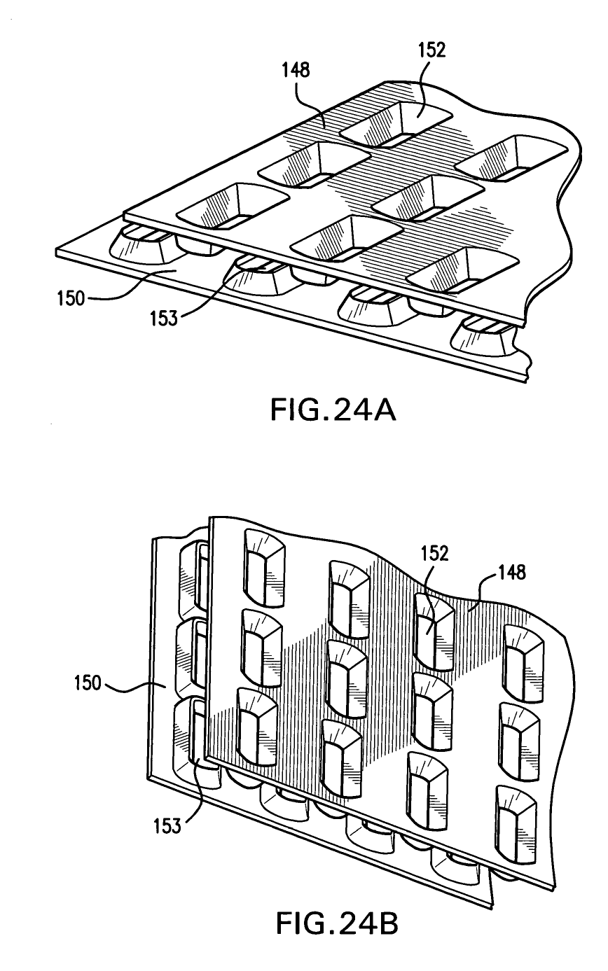

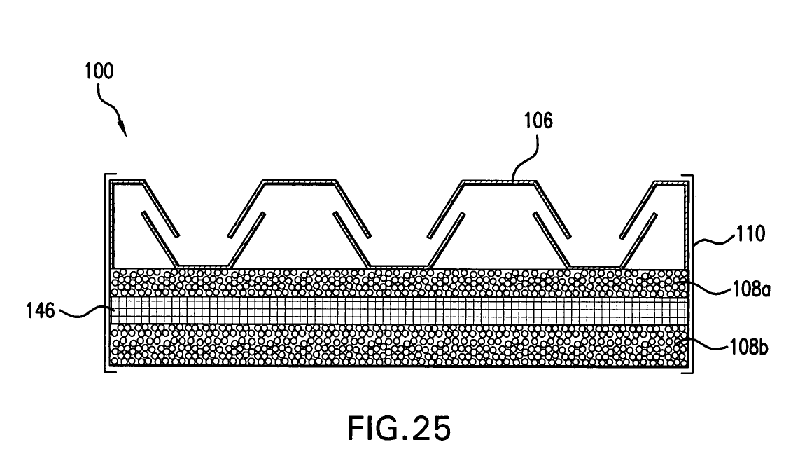

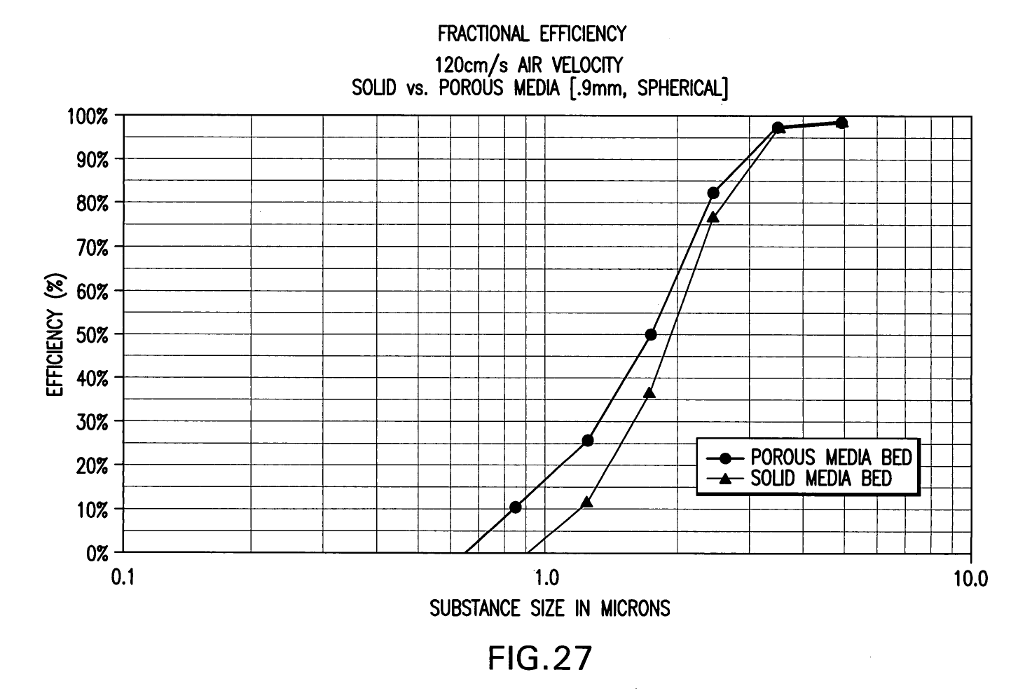

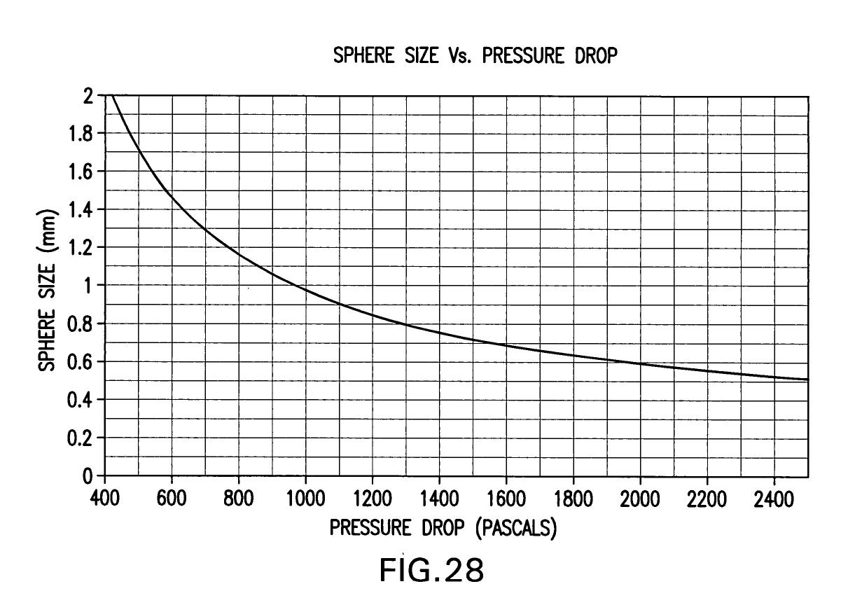

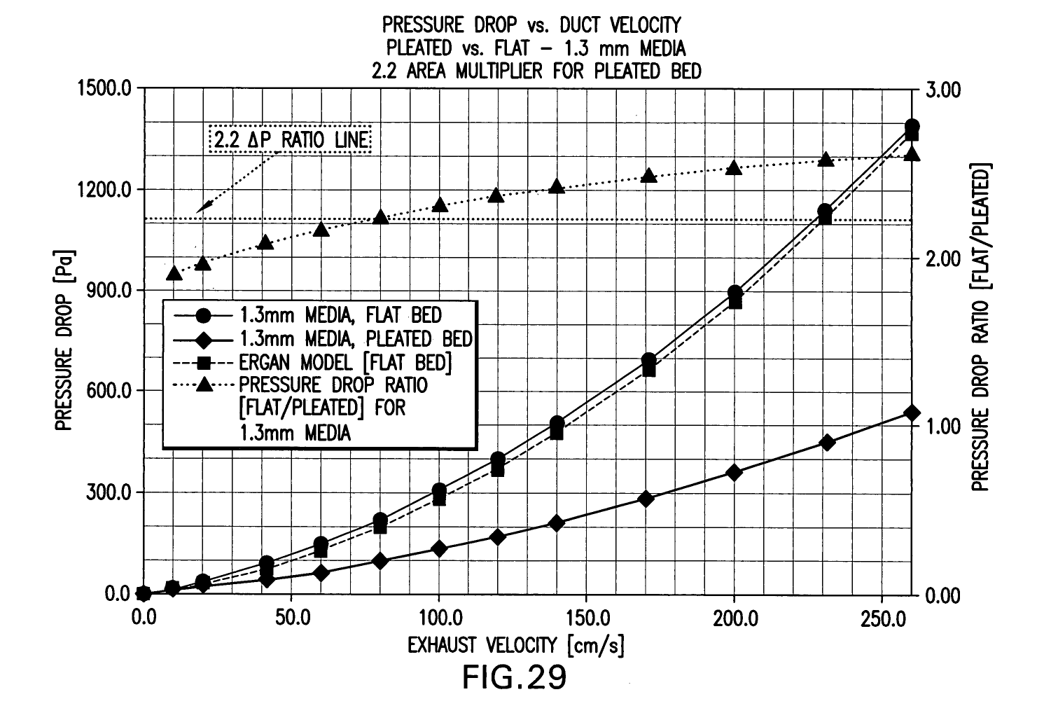

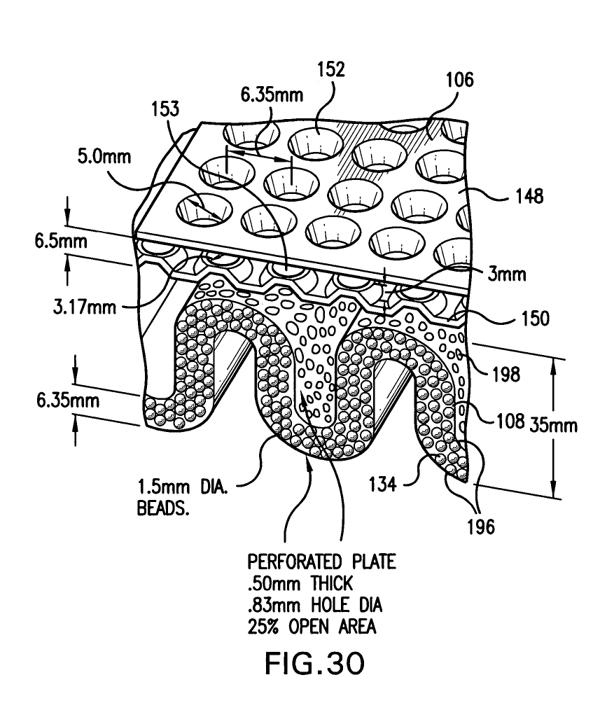

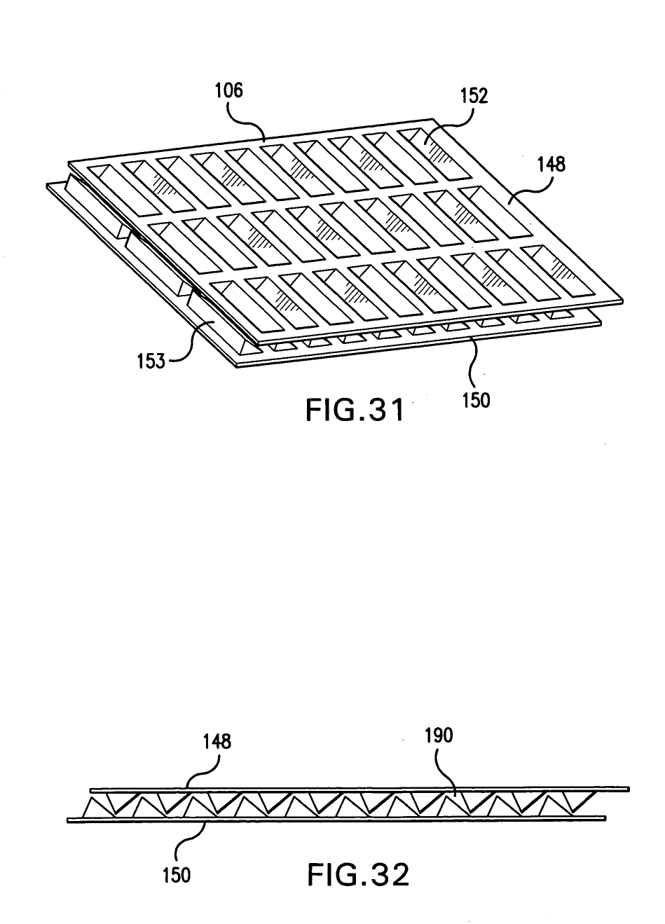

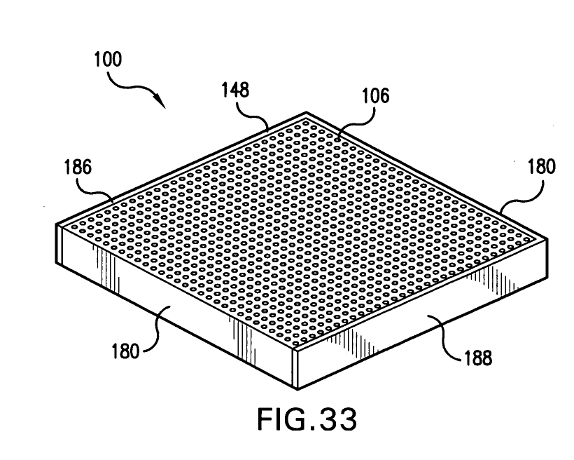

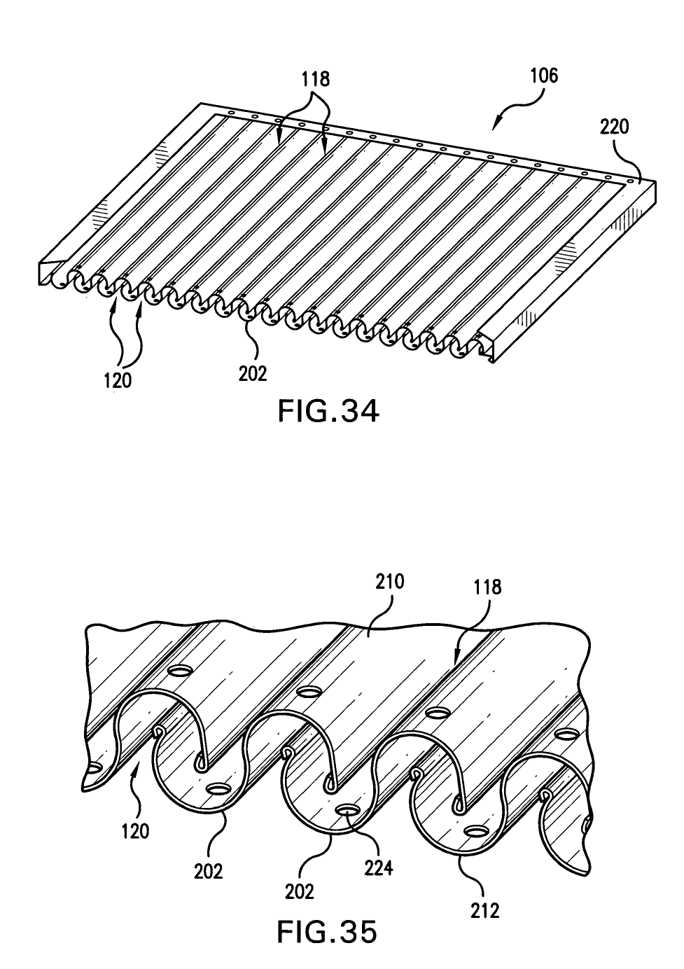

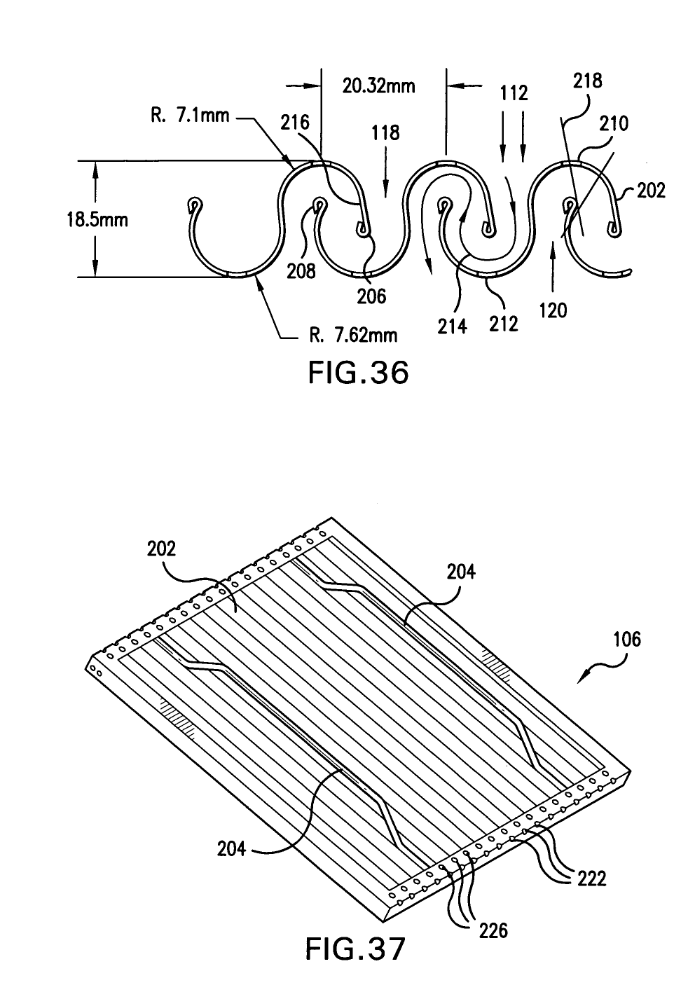

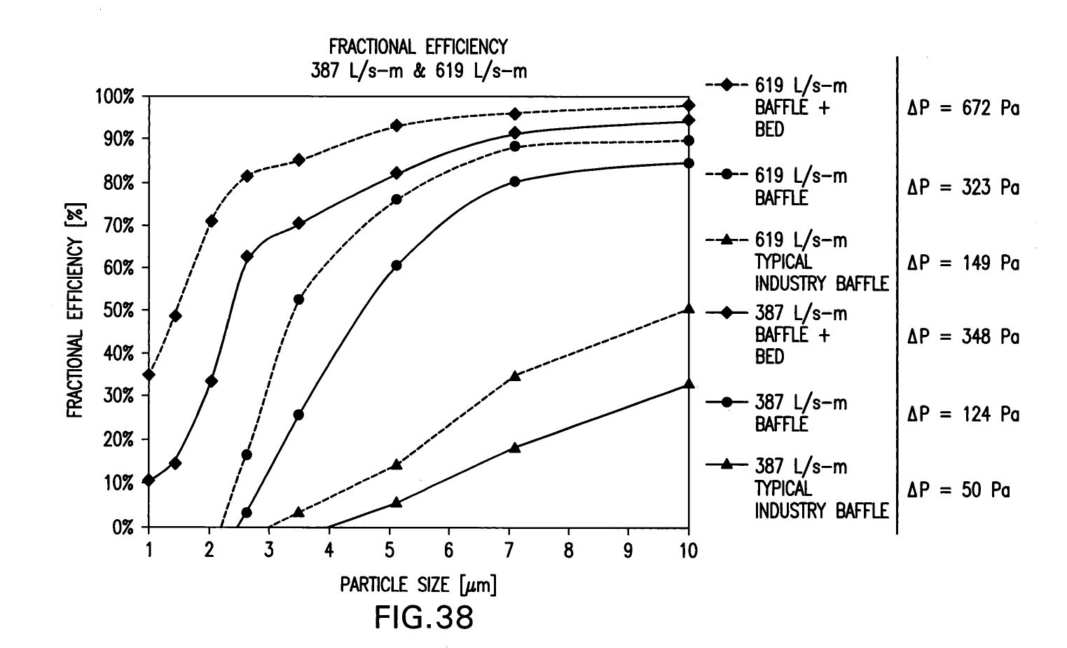

FIG. 2E shows a cross-sectional side view of a hood according to another exemplary embodiment.

FIG. 3 shows a cross-sectional side view of a separation cartridge according to another exemplary embodiment.

FIG. 4 shows a cross-sectional top view of a separation cartridge according to another exemplary embodiment.

FIG. 5 shows a perspective view of a baffle according to another exemplary embodiment.

FIGS. 6(a)-(g) show various pleated geometries for a packed bed according to another exemplary embodiment.

FIG. 7 shows a cross-sectional top view of a separation cartridge according to another exemplary embodiment.

FIG. 8 shows a cross-sectional side view of a separation cartridge according to another exemplary embodiment.

FIG. 9 shows a cross-sectional side view of a separation cartridge according to another exemplary embodiment.

FIG. 10 shows a cross-sectional side view of a hood according to another exemplary embodiment.

FIG. 11(a) shows a cross-sectional top view of a separation cartridge according to another exemplary embodiment.

FIG. 11(b) shows a cross-sectional top view of a separation cartridge according to another exemplary embodiment.

FIG. 12 shows a cross-sectional top view of a separation cartridge according to another exemplary embodiment.

FIG. 13 shows a cross-sectional top view of a separation cartridge according to another exemplary embodiment.

FIG. 14 shows a cross-sectional perspective view of a separation cartridge according to another exemplary embodiment.

FIG. 15a shows a perspective view of a baffle according to another exemplary embodiment.

FIG. 15b shows a plate for use in a baffle according to another exemplary embodiment.

FIG. 15c shows a plate for use in a baffle according to another exemplary embodiment.

FIG. 16 shows a graph pressure drop in pascals versus exhaust velocity in centimeters per second.

FIG. 17 shows a graph of separation efficiency (% of substance separated from a gas stream) for three exemplary embodiments of a baffle versus substance size in microns.

FIG. 18 shows a graph of pressure drop in pascals versus exhaust velocity in meters per second.

FIG. 19 shows an exploded perspective view of a separation cartridge according to another embodiment.

FIG. 20 shows a perspective view of a baffle according to another exemplary embodiment.

FIG. 21 shows a perspective view of a plate for a baffle according to another exemplary embodiment.

FIG. 22 shows a perspective view of a baffle according to another exemplary embodiment.

FIG. 23(a) shows a perspective view of a baffle according to another exemplary embodiment.

FIG. 23(b) shows a perspective view of a baffle according to another exemplary embodiment.

FIG. 24(a) shows a perspective view of a baffle according to another exemplary embodiment.

FIG. 24(b) shows a perspective view of a baffle according to another exemplary embodiment.

FIG. 25 shows a cross-sectional top view of a separation cartridge according to another exemplary embodiment.

FIG. 26 shows a cross-sectional top view of a separation cartridge according to another exemplary embodiment.

FIG. 27 is a graph of the separation efficiency for porous and solid media versus substance size in microns.

FIG. 28 is a graph of the media sphere size versus the pressure drop for an exemplary embodiment of a packed bed.

FIG. 29 is a graph of the pressure drop in pascals versus the exhaust velocity in centimeters per second for an exemplary embodiment of a pleated packed bed and a flat packed bed.

FIG. 30 shows a cross-sectional perspective view of a separation cartridge according to another exemplary embodiment.

FIG. 31 shows a perspective view of a baffle according to another exemplary embodiment.

FIG. 32 shows a side view of a baffle according to the embodiment shown in FIG. 31.

FIG. 33 shows a perspective view of a separation cartridge according to the embodiment of FIG. 19.

The following material was added with this application.

FIG. 34 shows a perspective view of a baffle according to another exemplary embodiment.

FIG. 35 shows a portion of a baffle according to another exemplary embodiment.

FIG. 36 shows a top view of a portion of a baffle according to another exemplary embodiment.

FIG. 37 shows a perspective view of a baffle according to another exemplary embodiment.

FIG. 38 is a graph of the efficiency of various embodiments of separation apparatuses and a conventional baffle.

### DETAILED DESCRIPTION OF EXEMPLARY EMBODIMENTS

The following material is from U.S. Provisional Application No. 60/272,044, filed on Mar. 1, 2001.

The present invention provides, inter alia, inorganic, porous particles that are capable of trapping oleo substances, preferably fat or oil. As used herein, a “oleo substance” is an oily substance, such as a grease or oil. By virtue of their hydrophobic (e.g. oleo-attractant) qualities, the particles are suitable for separating one or more oleo substances from a fluid flow (e.g. liquid or gas) that contains such oleo substances. To this end, the particles can be arranged into a packed bed-like formation, or network, such that the network comprises (1) particles interacting with each other and (2) interstices defined between the exterior surface area of the interacting particles. Thus, in one embodiment, a fluid in a gaseous or liquid state containing the oleo substances can flow through (or substantially through) the packed bed, leaving behind one or more oleo substances on or in the particles.

The fluid containing the oleo substances can be either a liquid or a gas. A preferred combination is one in which the oleo substance is a hot fatty grease or oil and the fluid is air. Although these embodiments are described as the fluid moving relative to the filter media, other embodiments such as those in which the filter media moves are also contemplated.

As indicated, the inorganic particles that comprise the filtration apparatus, or media, are porous, having an external surface area and a network of open channels that define internal surfaces. The inorganic particles can have any suitable shape, e.g., spherical or pellet-like, and may range in size from about 0.25-4 mm, preferably 0.33-3.5 mm, and more preferably 0.5-3 mm, while the pores preferably have a mean size between about 0.1 to 10 microns. The inorganic particles can have a porosity in the range of 30-70%. These internal surfaces accordingly are “exposed” to the to-be-filtered (e.g. oleo) substance(s) passing through the network of particles. That is, the pores of the inorganic particle or particles are large enough such that the filtered vapor can fit inside of, or otherwise pass through, one or more pores. Accordingly, the surfaces of the pores can comprise an oleophilic substance and, therefore, attract a oleo substance, such as grease. In this sense, a relatively powerful force, such as surface tension, can draw the oleo substance within the openings of the pores. Hence, a filtrate, such as an oleo substance can agglomerate within the pores in lieu of and/or in addition to adhering to the exterior surface area of the particles. It is preferred that the filtrate agglomerates within the pores to a greater extent than on the exterior surface area of the particles.

The open channels, e.g., pores, of the inorganic particle can exist in a reticulated, open, sintered structure. In this sense, a “reticulated” structure is a structure made up of a network of interconnected struts that form a strong, interconnected continuum of pores. A method for preparing a sinterable structure is disclosed in co-pending application Ser. No. 09/286,919, entitled “Sinterable Structures and Method”, which is hereby incorporated herein by reference in its entirety. More specifically, this co-pending application describes a processes for producing a porous, sintered structure, comprising (1) preparing a viscous mixture comprising a sinterable powder of ceramic or metal dispersed in a sol of a polymer in a primary solvent; (2) replacing the primary solvent with a secondary liquid in which the polymer is insoluble, thereby producing a gel which comprises an open polymeric network that has the sinterable powder arranged therein; (3) removing the secondary liquid from the gel; and (4) sintering the sinterable powder to form the open, porous structure.

The particles of the invention may be comprised of any inorganic material that confers the requisite characteristics upon the particles (e.g. capable of containing pores, attracts an oleo substance, at least substantially maintains porosity and ability to attract an oleo substance after treatment with a harsh filtrate-separation protocol). As used herein, an “oleo substance” is any hydrophobic substance, such as an oil or fatty material, that lacks an affinity for water. A “harsh” filtrate-separation protocol or “harsh condition” is one that causes the separation of the filtrate from the particle. Such protocol may be selected from the group consisting of heat treatment at a temperature sufficient volatalize of the hydrophobic substances and “bum off” any remaining residue (up to 800° C.), solvent extraction, and a detergent wash. An illustrative list of suitable materials of which the particles can be comprised include: a ceramic material such as transition metal oxides, zirconia, titania, silica, alumina, alumina-silica (clay) or a variable blend thereof. An especially preferred particle is a clay such as bentonite or montmorillonite.

The individual particles, once formed, can be assembled into a network suitable for filtering the one or more oleo substances from the moving fluid composition. The particles can be arranged as a packed bed in a vertical plane, a horizontal plane or both. Preferably, each particle interacts with at least one other particle, yet forms interstices between the particles, such that a fluid can pass through the interstices. In one embodiment, the particles are poured into a bed or casing that defines a constant surface area. The particles preferably extend along at least the horizontal or vertical cross section of the bed or casing to define a continuous section of alternating particles and interstices. An example is a packed bed of particles sandwiched between two screens. Alternatively, the particles physically may be attached, such as by heating the particles to a sufficient temperature, then fusing three or more particles together, while maintaining space between the particles sufficient to allow the passage of a vapor or liquid therethrough.

Once formed, the inorganic porous particles, which can be in the form of the network described above, can be placed into contact with a moving fluid composition containing an oleo substance. The particles may be positioned in association with a moving fluid such that the fluid passes through or at least substantially through the interstices and/or pores of inorganic particles, leaving behind at least a portion, but preferably the majority, of the oleo substance suspended in the fluid. In this sense, the oleo substance agglomerates on the inorganic particles, by virtue of the attraction that the particle has for the oleo substance.

As the fluid passes through the packed bed of inorganic particles, there is a drop in pressure of the fluid, due to the resistance provided by the inorganic particles. In a preferred embodiment, this drop in pressure remains substantially constant, which means that surface tension causes the oleo substance(s) to collect within the pores to a greater extent than in the interstices between the exterior surface area of the particles. However, the invention also contemplates a filtering process wherein the oleo substance agglomerates within the pores, as well as on the surface of the particles. At any time, the inorganic particles can be removed from the flow of fluid, in order to separate the oleo substance from inorganic particles. In some embodiments, the particles may be regenerated, in situ. However, it is preferred that the particles are removed from the fluid flow whenever the oleo substance or other filtrate at least substantially has filled the pores and/or substantially has filled the interstices between the inorganic particles. This conveniently can be determined by detecting a measurable decrease in the pressure of the fluid through the filter media.

The inorganic particles may be removed from the fluid flow in any number of ways. For instance, the particles can be a magnetic material and an external magnetic force may be applied to draw the particles away from the fluid flow. Alternatively, gravitational forces could be employed to move the particles downwardly, for example, beneath the flow of vapor. In addition, a vacuum force could be used to pull the particles out of the stream of flowing vapor. Further still, the invention contemplates the employment of a “see-saw” apparatus that has the filter media on both ends of pivoting elongated member, where the media can be raised and lowered from a filtering position to a regeneration position. In a similar manner, a rotating wheel or disk containing the filtering media can be rotated from a position of filtering to a position of separation and/or regeneration.

The separation step preferably is carried out such that, upon removing the oleo filtrate from the inorganic materials, the inorganic particles again can be used to filter an oleo substance from a moving stream of vapor, as before (i.e., they are regenerated. For instance, the oleo substance can be separated from the inorganic particles by heat treating the particle at temperatures described, above. Alternatively, the separation step can comprise solvent extraction or a detergent washing step. Suitable solvents for removing the oleo substance include: acetone or other known suitable solvent. A detergent suitable for the detergent washing step can be NaOH, which does not react with the oleo substance, but instead “charges” the surface area of the particles, thus separating the filtrate from the particles. Other known suitable detergents can also be used. After the oleo substance is removed from the inorganic particles, the undesired substance may be discarded and the particles can be re-positioned within the stream of the flowing fluid. The oleo collection and separation process can be repeated multiple times.

Of course, the filtration particles alternatively may be able to separate hydrophilic particles from a fluid composition, such as air. For instance, porous particles of the invention could at least contain hydrophilic surfaces within the porous area. The invention, accordingly, contemplates the removal of malodorous or toxic vapors from air. Current filtration apparatus in air conditioning systems, for example, might not effectively remove harmful vapors or droplets, such as those carrying the so-called “Legionaire's Disease.” A porous filter, as described herein, having surfaces adapted to be hydrophilic, could capture noxious vapors or droplets. Thereafter, the “trapped” vapors or droplets could be heated, thereby destroying any bacteria, virus or other harmful material associated with the vapors or droplets.

The invention also provides a system for substantially separating one or more oleo substances from a moving fluid stream. This “system” may comprise a packed bed of inorganic particles, as described, in combination with a series of vents or ducts that channel the fluid stream towards the network of particles. The system also may comprise a series of vents or ducts that channels the fluid to another location, upon passing through the network of inorganic particles. For instance, the fluid may exit into the atmosphere upon passing through the inorganic particles. Alternatively, the fluid first may pass through a catalytic converter.

The system also may comprise a housing for holding the oleo substance or substances in a liquid or solid state, before the substance is heated to a vaporous state or forms droplets. Upon forming into a vapor or droplets, the oleo substance can pass through the packed bed of inorganic particles. For example, if the oleo substance is an oil or grease, the housing can be a deep-fat fryer. Alternatively, the housing can be a griddle, which equally can produce an oleo vapor. Accordingly, upon being heated, the oil or grease becomes a vapor or droplets and substantially all of the vapor or droplets flow into contact with the inorganic substance.

The system can be constructed such that the housing that generates the fluid flow does not need to be turned off in order to perform the filtrate-removing step. To this end, the system may comprise multiple series of ducts or vents that can be operated in tandem with each other. Accordingly, one series of ducts or vents may be opened, while the others are closed. The “open” series would act to direct the vapor to the inorganic particles and then away from the particles after passing therethrough. At the appropriate time, the inorganic particles, having the oleo material agglomerated thereto, can be cleaned by a filtrate-separation protocol, for example. Further, the inorganic particles may remain substantially at their present location or they may be moved to a different location (e.g. by magnetic, vacuum or gravitational force) before separating the oleo substance(s) from the particles. At this stage, the “open” series of vents or ducts can be closed and the “closed” series then can be opened, as the filtering process continues.

The filtration system of the invention can be used in a number of contexts. For example, the system can be adapted to work with any device (e.g. a housing) that contains a composition that will be transformed into a vapor or form into droplets. A particularly suitable housing is a deep-fat fryer that contains grease or oil.

One non-limiting example of a filtration system contemplated by the invention is described in FIG. 1A. With reference to FIG. 1A, the housing (10) holds the oleo substance (e.g. oil or grease). Upon being heated within the housing (10), the exhaust (11) enters duct (13) through the opening (12), then enters duct (14) through opening (17), since valve (34) is closed and valve (15) is open. Valves (34) and (15) pivot about hinges (35) and (16), respectively. As the exhaust (11) enters duct (14), air pump (22) blows air (23) into duct (19) through opening (24) since valve (20) is pivoted about hinge (21) in the open position, while valve (38) is pivoted about the hinge (39) in the closed position. The air (23) continues through the duct (19) and then enters duct (14) at opening (18), causing a vacuum (25) through filter media (27). This vacuum (25) allows the air (23) and exhaust (11) to travel through the filter media (27).

The filter media (27) comprise a network of inorganic particles (29) within a housing (28). Particles (27) can enter housing (28) through opening (30) and leave housing (28) through opening (31). The arrangement of the particles (29) within the housing (28) provides interstices (26) between the particles (29). The housing (28) is permeable to exhaust flow (11) and air flow (23), so that exhaust flow (11) and air flow (23) can pass through housing (28). The oleo substance(s) within exhaust (11) is attracted to the particles (29) and gathers within interstices (26) and pores of the particles (not shown), as exhaust (11) passes through apparatus (27). Thereafter, exhaust (11) and air (23) pass into and through duct (32), which leads to catalytic converter (42). After passing through catalytic converter (42), exhaust (11) and air (23) pass into and through smoke stack (43); thereafter, exhaust (11) and air (23) exit into the atmosphere (46). Air pump (44) optionally supplies air flow (45) into catalytic converter (42) to assist in the flow of exhaust (11) and air (23) into smoke stack (43).

Filter media (27) is positioned adjacent to electric heater (47) having coil (48). When heater (47) is turned on, coil (48) can transfer heat to particles (29). The heat will cause the oleo substance (not pictured) to separate from the particles (29) and, through gravitational forces, pass downwardly through grease drain (49). Generally, the heat-separation process occurs in filter apparatus (27) after exhaust (11) has passed through apparatus (27) and after valve (15) pivots about hinge (16) to close duct (14). In addition, when duct (14) is closed, duct (33) can be opened by valve (34) pivoting about hinge (35). Exhaust (11) then can enter duct (33) through opening (36).

The following material is from U.S. patent application Ser. Nos. 10/076,144 and 10/363,849 and International Application No. PCT/US02/05753 the earliest of which was filed on Feb. 15, 2002.

The present invention provides, inter alia, inorganic, porous particles that are capable of trapping filtrate substances from a fluid. As used herein, “filtrate substance” is defined as the substance (e.g., gas, vapor, liquid, suspended droplets, etc.) that is intended to be removed from the fluid. The fluid containing the filtrate substance can be either a gas or liquid.

The particles are suitable for separating one or more of the filtrate substances from a fluid flow, e.g. a gas, which contains such filtrate substances. To this end, in a preferred embodiment, the inorganic particles can be arranged into a packed bed-like formation, or network, such that the network comprises (1) particles interacting with each other and (2) interstices defined between the exterior surface area of the interacting particles. Thus, in one embodiment, a fluid containing the filtrate substances can flow through (or substantially through) the packed bed, leaving behind one or more filtrate substances that collect within at least a portion of the particles. Although the embodiments described herein indicate that the fluid moves relative to the filter media, other embodiments such as those in which the filter media move are also contemplated.

A particularly preferred combination is one in which the filtrate substance is a grease, fat or oil (collectively referred to as an “oleo substance”) and the fluid is air.

As indicated, the inorganic particles, or media, that comprise the core of the filtration apparatus described more fully below, are porous, having an external surface area and a network of open channels that define internal surfaces. In a preferred embodiment, the inorganic particles can have any suitable shape, e.g., spherical, pellet-like, etc. The particles may have any suitable size depending on end use, and may range in size from about 0.25-4 mm, preferably 0.33-3.5 mm, and more preferably 0.5-3 mm. For non-spherical particles, the size measurement is taken at the largest dimension. In other suitable embodiments, the particles can have a size that ranges from greater than 4 mm, preferably from greater than 4 to 50 or even 100 mm. In some embodiments, the pores preferably have a mean size between about 0.01 to 100 microns, preferably 0.1 to 10 microns. The media can also have other shapes such as porous fibers and other formed shapes such as rings, saddles, etc.

The inorganic particles can have porosity in the range of 15-70%, preferably 30-70%. These internal surfaces accordingly are exposed to the filtrate substance (e.g. oleo) substance(s) passing through the network of particles. That is, the pores of the inorganic particle or particles are large enough such that the filtrate substance can fit inside of, or otherwise pass through, one or more pores. Accordingly, in one embodiment, the surfaces of the pores can comprise an oleophilic substance and, therefore, attract an oleo substance. In this sense, a relatively powerful force, such as surface tension, can draw the filtrate substance within the openings of the pores. Hence, the filtrate substance, such as an oleo substance, can collect within the pores in lieu of and/or in addition to adhering to the exterior surface area of the particles. In other embodiments, described more fully below, the interior and/or exterior of the particle can have a catalyst and/or reactant coated thereon.

The open channels, e.g., pores, of the inorganic particle in a preferred embodiment can exist in a reticulated, open, sintered structure. In this sense, a reticulated structure is a structure made up of a network of interconnected struts that form a strong, interconnected continuum of pores. A method for preparing a sinterable structure is disclosed in co-pending application Ser. No. 09/286,91.9, entitled “Sinterable Structures and Method”, which is hereby incorporated herein by reference in its entirety. More specifically, this co-pending application describes processes for producing a porous, sintered structure, comprising (1) preparing a viscous mixture comprising a sinterable powder of ceramic or metal dispersed in a sol of a polymer in a primary solvent; (2) replacing the primary solvent with a secondary liquid in which the polymer is insoluble, thereby producing a gel which comprises an open polymeric network that has the sinterable powder arranged therein; (3) removing the secondary liquid from the gel; and (4) sintering the sinterable powder to form the open, porous structure.

The particles of the invention may be comprised of any inorganic material that confers the requisite characteristics upon the particles (e.g. capable of containing pores, at least substantially maintains porosity and ability to collect a filtrate substance inside the pores of the particles after a filtrate-separation operation describe more fully below, preferably a harsh filtrate separation). An illustrative list of suitable materials of which the particles can be comprised include: a ceramic material such as transition metal oxides, zircon, zirconia, titania, silica, alumina, alumina-silica (clay) or a variable blend thereof. An especially preferred particle is a clay such as kaolin, bentonite or montmorillonite. Porous iron made by Ser. No. 09/286/919 also will absorb oleo substances.

The individual porous particles, once formed, can be assembled into a network suitable for filtering the one or more substances from the fluid composition. The porous particles can be arranged as a packed bed in a vertical plane, a horizontal plane or both. Preferably, each porous particle interacts with at least one other particle, yet forms interstices between the particles, such that a fluid can pass through the interstices. In one embodiment, the porous particles form a bed that defines a constant surface area. The particles preferably extend along at least the horizontal or vertical cross section of the bed or casing to define a continuous section of alternating particles and interstices. An example is a bed of porous particles packed within a perforated or porous wall container. Alternatively, two or more particles of the bed may be physically attached, such as by heating the particles to sufficient temperature to sinter the particles together, while maintaining space between the particles sufficient to allow the passage of a vapor or liquid there through.

Once formed, the inorganic porous particles, which can be in the form of the network described above, can be placed into contact with a fluid composition containing the filtrate substance, preferably an oleo substance. The particles may be positioned in association with a fluid such that the fluid passes through or at least substantially through the interstices and/or pores of inorganic particles, leaving behind at least a portion, but preferably the majority, of the filtrate substance suspended in the fluid. In this sense, the filtrate substance collects on and within the inorganic particles.

As the fluid passes through the packed bed of inorganic particles, there is resistance to the flow, resulting in a drop in pressure on the exit side of the bed. In a preferred embodiment, this drop in pressure remains substantially constant, which means that the filtrate substance collect within the pores to a greater extent than in the interstices between the exterior surface area of the particles. At any time, the inorganic particles can be removed from the flow of fluid, in order to separate the filtrate substance from inorganic particles. In some embodiments, the particles may be regenerated, in situ. However, it is preferred that the particles are removed from the fluid flow whenever the filtrate substance at least substantially has filled the pores and/or may have begun to fill the interstices between the inorganic particles. This conveniently can be determined by detecting a measurable decrease in the pressure of the fluid through the filter media.

The inorganic particles may be removed from the fluid flow in any number of ways, from simple replacement to automated systems. For instance, the particles can be a magnetic material and an external magnetic force may be applied to draw the particles away from the fluid flow, such as vapor flow. Alternatively, gravitational forces could be employed to move the particles downwardly, for example, beneath the fluid flow. In addition, a vacuum force could be used to pull the particles out of the stream of flowing fluid. Further still, the invention contemplates the employment of a see-saw apparatus that has the filter media on both ends of a pivoting-elongated member, where the media can be raised and lowered from a filtering position to a regeneration position. In a similar manner, a rotating wheel or disk containing the filtering media can be rotated from a position of filtering to a position of separation and/or regeneration.

The separation step preferably is carried out such that, upon removing the filtrate substance from the inorganic materials, the inorganic particles again can be used to filter a substance from a moving stream of fluid as before. Filtrate-separation operations may be selected from the group consisting of heat treatment at a temperature sufficient to volatilize the filtrate substances and burn off any remaining residue (up to 1000° C.), solvent extraction, detergent wash, and centrifugal removal, and combinations of these separations. Particularly preferred separation operations are harsh filtrate separations such as heat treatment and solvent extraction. Suitable solvents for removing the filtrate substance may include organic solvents or preferably known biodegradable solvents. A detergent suitable for the detergent washing step can be a commercial one, e.g., Dawn. Other known suitable detergents can also be used. A significant advantage of the present invention is that the inorganic porous particles are capable of withstanding harsh separation treatments where necessary as described above. After the filtrate substance is removed from the inorganic particles, the filtrate substance may be discarded and the particles can be re-positioned within the stream of the flowing fluid. The filtrate collection and separation process can be repeated multiple times.

In the catalytic embodiment, described below, the separation step can be facilitated by incorporation of the catalyst. Because the internal pores are completely available in the sintered structure of Ser. No. 09/285,919, a catalyst coated on the pore walls substantially increases the catalyst availability to reactants, e.g. hydrocarbons and oxygen.

In another embodiment, for instance, porous particles of the invention could contain hydrophilic surfaces within the porous area. The invention, accordingly, contemplates the removal of malodorous or toxic vapors from air. Current filtration apparatus in air conditioning systems, for example, might not effectively remove harmful vapors or droplets, such as those carrying spores or bacteria, e.g. the so-called “Legionnaire's Disease.” A porous filter, as described herein, having surfaces adapted to be hydrophilic, could capture noxious vapors or droplets. Thereafter, the trapped vapors or droplets could be heated, thereby destroying any bacteria, spores, virus or other harmful material associated with the vapors or droplets. In a preferred embodiment, the surfaces of the pores, such as struts, can be coated or impregnated with a biocidal agent, such as well known silver containing biocides, e.g., silver iodide and/or antibiotics, e.g., tetracycline. Another possible coating could include diazeniumdiolate in a siloxane polymer. Of course, the exterior surface of the porous particles can also be coated or impregnated with a biocidal agent.

In still another embodiment, the filtrate substance is treated and subsequently removed by reacting the filtrate substance using a catalyst that is within the pores and on the exterior surface of the particles. Optionally, the filtrate substance can be reacted with another component that may be coated on the particle, in the fluid, or even the fluid itself. In one embodiment, ethane can be reacted in and subsequently removed from a gas stream by converting the ethane to ethylene in the presence of hydrogen using a noble metal catalyst on the surface and within the pores of the particles. This catalytic reaction can occur by passing the fluid over or through a bed of the inorganic particles, or within a fluidized bed of the same particles.

The invention also provides an apparatus for substantially separating one or more filtrate substances from a moving fluid stream. This apparatus may comprise a packed bed or network of inorganic particles, as described, in combination with a series of vents or ducts that channel the fluid stream towards the network of inorganic particles. The system also may comprise a series of vents or ducts that channel the fluid to another location, upon passing through the network of inorganic particles. For instance, the fluid may exit into the atmosphere upon passing through the inorganic particles. Alternatively, the fluid first may pass through a catalyst bed for further treatment of the fluid.

The system can be constructed such that the source creating the fluid flow does not need to be turned off in order to perform the filtrate substance removing step. To this end, the system may comprise multiple series of ducts or vents that can be operated in tandem with each other. Accordingly, one series of ducts or vents may be opened, while the others are closed. The open series would act to direct the fluid, such as a vapor, to the inorganic particles and then away from the particles after passing there through. At the appropriate time, the inorganic particles, having the filtrate substance collected therein, can be cleaned by a filtrate-separation protocol, for example. Further, the inorganic particles may remain substantially at their present location or they may be moved to a different location (e.g. by magnetic, vacuum or gravitational force) before separating the filtrate substance(s) from the particles. At this stage, the open series of vents or ducts can be closed and the closed series then can be opened, as the filtering process continues.

One non-limiting example of a filtration apparatus contemplated by the invention is described in the schematic diagram of FIG. 1B. With reference to FIG. 1B, housing (51) holds the filtrate substance, e.g., an oleo substance. Upon being heated within the housing, the filtrate substance in a fluid (in this instance in a stream of flowing exhaust air) enters duct (52). The filtrate substance can then be selectively passed into duct (53) or (54), such as by a valve. The filtrate substance enters the filter media (55) or (56), that includes the network of inorganic particles. A pre-filter (not shown) may be positioned before the filter media.

The filtrate substance collects within interstices and pores of the particles (not shown), as the exhaust passes through the filter media. Thereafter, the exhaust passes into and through ducts (57) or (58) which lead to catalytic reactor (59). After passing through catalytic reactor (59), the exhaust can be vented into the atmosphere (60).

The filter media can be positioned adjacent to electric heater (not shown), that, when activated, can transfer heat to particles in the filter media. The heat will cause the filtrate substance, such as an oleo substance (not pictured) to separate from the particles that can be drained as needed. Generally, the heat-separation process occurs when the apparatus is shut down, or when the fluid flow directed into the other filter media.

Another embodiment is shown in connection with FIGS. 2A-2D. With reference to FIG. 2A, housing (61) holds the filtrate substance, e.g., an oleo substance. Upon being heated within the housing, the filtrate substance enters duct (62). The filtrate substance then enters into filter media (66). FIG. 2D shows the cross section of filter media 66 taken along line I-I. In an embodiment shown in FIG. 2B, the filtrate substance can then be selectively passed into duct (64) or (65), such as by a valve (63), and then enter the filter media (66) or (67), that includes the network of inorganic particles. A pre-filter (not shown) may be positioned before the filter media.

Thereafter, in the embodiment of FIGS. 2A and 2B, the exhaust gas passes into fan (68) and is vented into the atmosphere through vent (69). In the embodiment shown in FIG. 2C, the exhaust first passes into catalytic reactor (70) before passing into fan (68).

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims and their equivalents.

As used herein and in the following claims, articles such as “the,” “a” and “an” can connote the singular or plural. All documents referred to herein are specifically incorporated herein by reference in their entireties.

The following material is from U.S. patent application Ser. No. 10/632,805, filed on Aug. 4, 2003.

With reference to the accompanying Figs., the present disclosure relates to separation apparatuses (e.g., separation cartridges, various configurations of separation mediums, etc.) for use in hoods (e.g., commercial kitchen hoods, residential kitchen hoods, etc.), methods of producing such separation apparatuses, and hood systems which utilize such apparatuses. While the subject matter herein is presented in the context of the use of such apparatuses in the field of hoods, such separation apparatuses may be utilized in alternative applications, as will be appreciated by those of ordinary skill (e.g., laboratory hoods, air separation systems, paintspray booths, etc.). The substances collected by the separation apparatuses may include common exhaust substances such as cooking by-products (e.g., grease, soot, etc.). Of course, the separation apparatuses may also be capable of filtering and/or collecting other types of organic, inorganic, hydrophobic, hydrophilic, and/or amphiphilic particles, and may include living organisms such as bacteria and viruses. Also, the particular features and advantages described with regard to one embodiment may also apply to one or all of the other embodiments to the extent possible and/or desirable unless noted otherwise.

Referring to FIG. 1C, a cross-sectional side perspective view of an exemplary embodiment of a hood 80 is shown. Hood 80 includes a plurality of separation cartridges 100, a grease trough 82, an exhaust chamber 86, and an exhaust chamber outlet 88. As shown, hood 80 is a tapered canopy hood. However, in other embodiments, hood 80 may be any of a number of different types of hoods such as a box canopy, a V-bank box canopy, etc. that are suitable for use with the separation apparatuses disclosed herein.

In an exemplary embodiment, hood 80 is part of a system that is used to vent cooking exhaust (i.e., air or gas stream including entrained substances) from the interior of a structure, where the cooking is taking place, to the exterior of the structure and into the atmosphere. In addition to hood 80, the system includes ductwork and a fan. The ductwork is coupled to exhaust chamber outlet 88 and extends to the outside of the structure. The fan is used to move the exhaust from hood 80, through the ductwork, and outside of the structure. In one embodiment, the fan is coupled to the ductwork at a position exterior to the structure. In another exemplary embodiment, hood 80 may be part of system that is configured to vent other forms of exhaust. In this embodiment, the system may also include ductwork and fan.

Separation cartridges 100 are generally used to separate substances such as grease, soot, etc. from the gas or air in the exhaust, thus preventing the grease from accumulating in exhaust chamber 86, on the ductwork, and/or at the outlet of the ductwork. Typically, if the substance is grease, then the grease is collected in trough 82. Trough 82 may be configured so that the grease flows into a grease collector. For example, trough 82 may be configured to be sloped so that the grease flows to one or more collectors that allow the grease to be disposed of easily. Accordingly, the collectors may be of any suitable configuration. In one configuration, the collectors can be removed from hood 80. In another configuration, the collectors may also be configured to be permanently affixed to hood 80.

In an exemplary embodiment, separation cartridges 100 are positioned near the opening of exhaust chamber 86. Generally, this position is desirable because the grease is removed before entering exhaust chamber 86 and/or the ductwork. However, in another embodiment, separation cartridges 100 may be positioned in the ductwork or adjacent exhaust chamber outlet 88. In short, separation cartridges 100 may be positioned in any suitable location in hood 80 to provide the desired separation capability.

Referring to FIG. 2E, a cross-sectional side view of hood 80 is shown. In an exemplary embodiment, as shown in FIG. 2E, one of separation cartridges 100 is positioned in hood 80 using an upper railing 102 and a lower railing 104. Upper railing 102 extends downward and away from a top 90 of hood 80 and towards a side 92 of hood 80. Lower railing 104 extends upward and outward from side 92 towards top 90. Railings 102 and 104 can be substantially U-shaped, as shown, but can also take other shapes to hold separation cartridge 100 in place. Separation cartridges 100 are configured to be received by and extend between upper railing 102 and lower railing 104.

FIG. 3 shows an exemplary embodiment of one of separation cartridges 100 positioned between upper and lower railings 102 and 104 of hood 80. Separation cartridge 100 is positioned as shown by inserting a top side 105 of separation cartridge 100 into upper railing 102 until a bottom side 107 of separation cartridge 100 is able to clear lower railing 104. Bottom side 107 is then moved to a position in line with lower railing 104. At this point, separation cartridge 100 is lowered so that bottom side 107 is positioned in lower railing 104. When bottom side 107 is in lower railing 104, top side 105 is held in place by upper railing 102. However, by lowering bottom side 107, a space 94 is created between top side 105 and upper railing 102. Accordingly, this configuration allows separation cartridge 100 to be easily removed from hood 80 for periodic cleaning and, if necessary, to be replaced.

Of course, other embodiments may be used to position separation cartridge 100 in hood 80. In one embodiment, top side 105 may include a lip with a downward bent leading edge that meshes with a corresponding lip on hood 80 having an upward bent leading edge. In another embodiment, separation cartridge 100 may be positioned in hood 80 using a flip-up clasp. Accordingly, any of a number of suitable devices may be used to position separation cartridge 100 in hood 80.

In an exemplary embodiment, separation cartridge 100 includes at least two separation mediums (e.g., baffle, packed bed, mesh filter, etc.). The separation mediums may separate an entrained substance from a gas or air stream using any of a number of known mechanisms. In one embodiment, the separation medium may be configured to separate an entrained substance using impaction. Impaction occurs when the inertia of a substance in the exhaust causes the substance to impact one or more surfaces of the separation medium. After impacting the surface, the substance typically drains away. In another embodiment, the separation medium may be configured to separate an entrained substance by sieving or capturing the substance in the interstices of a material. In another embodiment, the separation medium may be configured to adsorb and/or absorb the substance. In short, the separation mediums may use any suitable mechanical, electrostatic, and/or chemical mechanism to remove an entrained substance from a gas or air stream. Of course, an individual separation medium may be configured to use one or more of the above described mechanisms.

In an exemplary embodiment, separation cartridge 100 is a stand alone modular structure. The modular structure of separation cartridge 100 may be advantageous because it reduces the number of parts as well as the cost of the overall hood. Also, a modular structure makes it easier to install and remove and makes it easier for separation cartridge 100 to be used in existing hood systems.

Referring to FIG. 4, a cross sectional top view of an exemplary embodiment of a separation cartridge 100 is shown. As shown in FIG. 4, separation cartridge 100 includes a baffle 106, a packed bed 108, and a frame 110.

It should be understood that, although FIG. 4 shows separation cartridge 100 comprising baffle 106 and packed bed 108, separation cartridge 100 may include any of a number of configurations of separation mediums. For example, in another embodiment, separation cartridge 100 may include a baffle and a mesh filter. In another embodiment, separation cartridge 100 may include a mesh filter and a packed bed. In another embodiment separation cartridge 100 may include a baffle, mesh filter, and a packed bed.

Frame 110 is used to hold baffle 106 and packed bed 108 in position. Frame 110 has a first side 114 and a second side 116. In one embodiment, baffle 106 and packed bed 108 are removably coupled to first and second sides 114 and 116. Thus, if baffle 106 or packed bed 108 needs to be cleaned or replaced, it can be cleaned or replaced individually rather than requiring the entire separation cartridge 100 to be cleaned or replaced. In another embodiment, frame 110 is configured to enclose baffle 106 and packed bed 108 in a removable manner. For example, frame 110 may be configured to pivotably open to allow baffle 106 and packed bed 108 to be removed. Frame 110 may use a hinge on one of its sides so that frame 110 opens in a clamshell type manner. In another embodiment, baffle 106 and packed bed 108 may be fixedly coupled to first and second sides 114 and 116. In another embodiment, baffle 106, packed bed 108, and frame 110 may be fixedly coupled together in a one-piece structure so that they cannot be removed from each other without substantial disassembly of separation cartridge 100 (e.g., baffle 106, packed bed 108, and frame 110 are welded together, etc.).

In an exemplary embodiment, separation cartridge 100 may be configured so that baffle 106 and packed bed 108 are spaced apart. The space between baffle 106 and packed bed 108 is used to alter the flow of the exhaust through separation cartridge 100. In another embodiment baffle 106 and packed bed 108 are configured to be in contact with each other. This may be desirable in situations where space is at a premium.

Referring to FIGS. 4 and 5, an exemplary embodiment of baffle 106 is shown. Baffle 106 includes entry openings 118, exit openings 120, a first row of deflectors 122, and a second row of deflectors 124. In general, entry openings 118 are where the exhaust enters baffle 106 and exit openings 120 are where the exhaust exits baffle 106. The first row of deflectors 122 define at least a portion of the entry openings 118 and is perpendicular to the width of separation cartridge 100. The second row of deflectors 124 define at least a portion of the exit openings 120 and is also perpendicular to the width of separation cartridge 100. As shown, deflectors 122 include outwardly extending side walls 126 and bases 128. Deflectors 124 include outwardly extending side walls 130 and bases 132. In general, side walls 126 of deflectors 122 face side walls 130 of deflectors 124 in an offset opposing relationship. Thus, bases 128 are positioned opposite exit openings 120 and bases 132 are positioned opposite entry openings 118.

Referring to FIG. 20, another exemplary embodiment of baffle 106 is shown. In this embodiment, side walls 126 and 130 are generally curved and include lips 127 and 131, respectively. It should be understood that baffle 106 may be configured in any of a number of ways. Also, to the extent that baffle 106 includes side walls 126 and/or 130, they may be any suitable shape such as flat, curved, etc.

The opposing rows of deflectors 122 and 124 prevents the exhaust from passing directly through without being deflected. In general, the exhaust passes through entry openings 118 and is deflected by deflectors 124 so that the exhaust passes between side walls 126 and 130. The exhaust is then deflected again by deflectors 122 before it passes out of exit openings 120 and into packed bed 108.

As the exhaust travels through baffle 106 and is deflected by deflectors 122 and 124, the larger substances, such as entrained grease, collide with deflectors 122 and 124 and run down to grease trough 82. The substances can then be disposed of accordingly.

Referring to FIG. 26, another exemplary embodiment of baffle 106 is shown. In this embodiment, baffle 106 includes first and second rows of deflectors 122 and 124 where each row is configured to traverse the width of separation cartridge 100. In this embodiment, deflectors 122 are generally curved and extend outwardly from walls 121. Deflectors 124 are also generally curved and extend outwardly from walls 121 towards deflectors 122. Deflectors 122 and 124 overlap so that exhaust passing through entry openings 118 is deflected as it travels between deflectors 122 and 124 before passing through exit openings 120.

In an exemplary embodiment, shown in FIGS. 4 and 26, packed bed 108 comprises media 134 that is used to separate the entrained substances from the exhaust. In general, packed bed 108 uses a variety of the mechanisms described above to separate entrained substances from a gas or air stream. For example, the entrained substances may be separated from a gas or air stream by causing the heavier substances to impact the media and drain away. Also, the substances may be entrapped in the interstices of media 134. Further still, the substances may be adsorbed by media 134. When media 134 is porous, the substances may also be absorbed. Accordingly, packed bed 108 may operate to separate entrained substances using impaction, sieving, adsorption, and/or absorption. Of course, packed bed 108 may also use other mechanisms to separate entrained substances.

In an exemplary embodiment, media 134 comprises porous and/or solid inorganic media as described in U.S. patent application Ser. No. 10/363,849, filed on Mar. 14, 2003. In an exemplary embodiment, media 134 comprises porous inorganic media that generally has an external surface area and a network of pores that define internal surfaces. The use of porous media may be advantageous because the pores can absorb the captured substances and, thus, increase the amount of time between cleanings as opposed to solid media. In an exemplary embodiment, the pores have a mean size between approximately 0.01 to approximately 100 microns or, desirably, between approximately 0.1 microns to approximately 10 microns. In one embodiment, the media includes a distribution of pore sizes ranging from approximately 0.1 microns to approximately 100 microns, or, desirably, from approximately 0.1 microns to approximately 10 microns.

In an exemplary embodiment, porous inorganic media may have a porosity in the range of 15-95%, desirably 30-70%. These internal surfaces accordingly are exposed to the substance(s) passing through the network of particles. That is, the pores of the inorganic media are large enough such that the substances can fit inside of, or otherwise pass through, one or more pores. Accordingly, in one embodiment, the surfaces of the pores can comprise an oleophilic substance and, therefore, attract an oleo substance (e.g., grease). In this sense, a relatively powerful, force, such as surface tension, can draw the substance within the openings of the pores. Hence, the substance, such as an oleo substance, can collect within the pores in lieu of and/or in addition to adhering to the exterior surface area of the particles.

Porous and/or solid inorganic media may comprise any inorganic material that confers the requisite characteristics upon the media (e.g. capable of containing pores, at least substantially maintains porosity and ability to collect a substance inside the pores of the media). An illustrative list of suitable materials of which the media can be comprised include: metals and their oxides, ceramic materials such as transition metal oxides, zircon, zirconia, titania, silica, alumina, alumina-silica (clay) or a variable blend thereof. In one embodiment, the media is a clay such as kaolin, bentonite or montmorillonite. Porous iron also absorbs oleo substances such as grease.

The porous and/or solid inorganic media particles can have any suitable shape (e.g., spherical, pellet-like, fibers, rings, saddles, etc.). Also, the media may have any suitable size depending on the particular use. For example, the media may range in size from about 0.25-4 mm, or, desirably, 0.33-3.5 mm, or, suitably, 0.5-3 mm. For spherical media, the size measurement is diameter of the particle; and for non-spherical media, the size measurement is taken at the largest dimension. In one embodiment, media particles can have a size that ranges from greater than 4 mm and, desirably, from greater than 4 millimeters to 50 millimeters or even 100 millimeters. In an exemplary embodiment, the media particles may comprise a plurality of particle sizes (e.g., particles of two, three, four, or more sizes as well as a distribution of particle sizes). For example, media 134 may include particles that are 4 millimeters and 10 millimeters in size. In another exemplary embodiment, the media particles may include a distribution of particle sizes so that at least approximately 80%, or, desirably, at least approximately 90%, or suitably, substantially all of the particles fall within a range of particle sizes (e.g., approximately 0.5 millimeters to approximately 2 millimeters, or desirably approximately 0.9 millimeters to approximately 1.7 millimeters). In another embodiment, the media particles may be configured to be of all different sizes and shapes.

The individual media particles, once formed, can be assembled into a network suitable for filtering the one or more substances from the fluid composition. Media 134 can be arranged as a packed bed 108 in a vertical plane, a horizontal plane or both. Preferably, each particle interacts with at least one other particle, yet forms interstices between the particles, such that a fluid can pass through the interstices. In one embodiment, the porous particles form a bed that defines a constant surface area. The particles preferably extend along at least the horizontal or vertical cross section of the bed or casing to define a continuous section of alternating particles and interstices. An example is a bed of particles packed within a perforated or porous wall container. Alternatively, two or more particles of the bed may be physically attached, such as by heating the particles to sufficient temperature to sinter the particles together, while maintaining space between the particles sufficient to allow the passage of a fluid there through.

Once formed, media 134, which can be in the form of the network described above, can be placed into contact with a fluid composition, such as exhaust (e.g., cooking exhaust, etc.), containing the substance to be filtered. The particles may be positioned in association with a fluid such that the fluid passes through or at least substantially through the interstices and/or pores of inorganic particles, leaving behind at least a portion, but desirably the majority, of the substance suspended in the fluid. In this sense, the substance collects on and within the inorganic particles.

In an exemplary embodiment, the pressure drop across packed bed 108 is configured to be suitable for hoods such as commercial kitchen hoods or other similar hoods. For example, packed bed 108 may have a pressure drop of not greater than approximately 500 pascals, or desirably, not greater than approximately 375 pascals. Of course, the particular pressure drop across packed bed 108 is dependent on the conditions of its use. Accordingly, the pressure drop across packed bed 108 may be any suitable pressure drop. As a general rule, there is a tradeoff between separation efficiency and pressure drop. Typically, as the pressure drop increases the efficiency of packed bed 108 increases.

The pressure drop across packed bed 108 may be dependent on a number of characteristics such as the bed depth, media size, and exhaust velocity (the velocity of the fluid flowing through the separation apparatus is the face velocity unless noted otherwise). The Ergun equation shown below may be used to model the pressure drop across a packed bed.

$$\frac{Δ p}{{D}_{b}} = 150 \cdot \frac{{( 1 - ϵ )}^{2}}{{ϵ}^{3}} \frac{{μ}_{f} \cdot U}{{( ϕ \cdot {d}_{m} )}^{2}} + 1.75 \cdot \frac{( 1 - ϵ )}{{ϵ}^{3}} \frac{{ρ}_{f} \cdot {U}^{2}}{ϕ \cdot {d}_{m}}$$

The variables in the Ergun equation are as follows. ε is the void volume of packed bed 108. μ_{ƒ} is the viscosity of the fluid passing through packed bed 108. U is the superficial velocity, which is ν·ε where ν is the mean fluid velocity. dₘ is the mean particle size (e.g., diameter of spherical particles, largest dimension for non-spherical particles, etc.). ρ_{ƒ} is the density of the fluid. D_{b} is the bed depth of packed bed 108. φ is the shape correction factor, which varies from 0 to 1.0.

Generally, as may be seen from the Ergun equation, as the bed depth increases, the pressure drop also increases. Likewise, as the media size increases, the pressure drop decreases. Also, as the exhaust velocity increases, the pressure drop increases.

In general, it is desirable to decrease the pressure drop across packed bed 108 and still provide the desired separation efficiency. Decreasing the pressure drop may reduce the size requirements of the fan that is used in conjunction with hood 80 and may result in less energy being used to move the exhaust through hood 80.

In an exemplary embodiment, shown in FIG. 4, packed bed 108 has a pleated shape. This configuration reduces the pressure drop relative to a flat packed bed. The smaller pressure drop is due to the larger cross sectional area of packed bed 108 through which the exhaust can pass. Assuming a constant volumetric flow of exhaust, the increased cross-sectional area for the exhaust to pass through results in a lower exhaust velocity at packed bed 108 and, hence, a lower pressure drop.

Referring to FIG. 6, a number of examples of pleated geometries for packed bed 108 are shown. These examples show how the geometry of packed bed 108 affects the cross sectional area through which the exhaust flows. The increased cross sectional area of a pleated packed bed may be represented as a multiple of the cross sectional area of a flat packed bed. This number is referred to as the multiplier factor. The multiplier factor is determined using the following equation:

$$Multiplier factor = \frac{( length of each pleat ) \cdot ( Number of pleats )}{Length of a flat packed bed}$$

It should be noted that this equation is a simplified version (i.e., the height of the pleated packed bed and the flat packed bed is assumed to be the same and thus cancels out leaving only the length) of the full equation, which would be written as the cross sectional area of the pleated packed bed divided by the cross-sectional area of the flat packed bed.

By knowing the effect on the pressure drop, the geometry of packed bed 108 can be chosen to meet the pressure drop requirements of a particular hood. For example, if separation cartridge 100 is used to replace a different type of filter in an existing hood, it may be undesirable to increase the pressure drop and thus decrease the amount of air that the hood is capable of handling. In order to prevent this from happening, the pressure drop of separation cartridge 100 may be designed to be similar to that of the filter previously used in the hood. This may be done by adjusting the parameters in the above equation to provide an acceptable multiplier factor. Of course, the variables shown in the Ergun equation may also be modified as well (e.g., width of the packed bed, media size, etc.).

Using FIG. 6(a) as an example, the multiplier factor is obtained for a particular pleated geometry as follows. The first step in the process is to determine the length of each pleat that has a rectangular cross section (this length is represented by 138 in FIG. 6 for the various pleated geometries). This length is then multiplied by the total number of pleats as shown in the above equation. The length of each pleat in FIG. 6(a) is 2.98 centimeters. The number of pleats is 7.5 and the length of a flat packed bed is 10.49 centimeters. Using these numbers in the equation results in a multiplier factor of approximately 2.1. The multiplier factors for the remaining geometries may be obtained in a similar manner. Table 1 shows the multiplier factors for each of the geometries shown in FIG. 6 as well as the parameters used to obtain the factors. It should be noted that the length of the pleats for FIG. 6(g) was adjusted to account for the turns in the pleat that are unaccounted for otherwise.

TABLE 1

| | Length of | Number of | |
|---|---|---|---|
| Figure | Pleat (cm) | Pleats | Multiplier Factor |
| FIG. 6(a) | 2.98 | 7.5 | 2.1 |
| FIG. 6(b) | 6.38 | 4.15 | 2.5 |
| FIG. 6(c) | 3.76 | 6 | 2.15 |
| FIG. 6(d) | 6.32 | 5 | 3.0 |
| FIG. 6(e) | 4.39 | 5 | 2.1 |
| FIG. 6(f) | 4.92 | 4.15 | 1.95 |
| FIG. 6(g) | 5.46 | 10 | 4.65 |

In the embodiment shown in FIG. 4, exhaust passes through separation cartridge 100 in the direction shown by arrows 112. In this manner, the exhaust initially passes through baffle 106 to remove the larger substances and is then passed through packed bed 108 to remove the smaller substances. This configuration of separation cartridge 100 is generally desirable because baffle 106 may not be as efficient at removing substances smaller than a certain size (e.g., ten microns or eight microns) as packed bed 108. Accordingly, baffle 106 is used to remove the larger substances first and then packed bed 108 is used to remove the smaller substances as well as any larger substances that may have passed through baffle 106. In an alternative embodiment, packed bed 108 may be placed in front of baffle 106 so that the exhaust first passes through packed bed 108.

Referring to FIG. 7, a cross-sectional top view of an exemplary embodiment of separation cartridge 100 is shown. In this embodiment packed bed 108 is flat. This configuration may be suitable for those situations where there is not enough space in separation cartridge 100 to allow flat bed 100 to be pleated. Of course, as explained previously, the geometry of packed bed 108 may depend on a number of factors unique to the particular application.

In an exemplary embodiment, separation cartridge 100 is configured to be used in an already existing hood. Advantageously, this allows separation cartridge 100 to be used to replace cartridges that may be used in existing hoods. In conventional existing kitchen hoods, the width of railings 102 and 104 is typically approximately 1.3 centimeters to approximately 7.6 centimeters and, more desirably, is approximately 3.5 centimeters to approximately 5.1 centimeters. Accordingly, separation cartridge 100 may be approximately 2.6 centimeters to approximately 6.4 centimeters wide or, desirably, approximately 3.8 centimeters to approximately 4.8 centimeters wide. Of course, separation cartridge 100 may be configured to be any size that corresponds to the particular hood. In an alternative embodiment, separation cartridge 100 may be incorporated into a newly built hood that is custom designed to use separation cartridge 100. In this embodiment, separation cartridge 100 may be any of a number of suitable dimensions.

Referring to FIGS. 8 and 9, cross-sectional side views of further embodiments of separation cartridge 100 are shown. In these embodiments, the height, represented by arrow 142, of packed bed 108 is reduced relative to that of baffle 106. This is done so that a second separation medium such as packed bed 108 may be used with existing baffles. Thus, baffle 106, in this embodiment, represents a commercially available baffle that is traditionally used in conjunction with hood 80. The height of packed bed 108 was reduced so that separation cartridge 100 would still fit in railings 102 and 104.

In an exemplary embodiment, as shown in FIG. 8, baffle 106 and packed bed 108 are coupled together using frame 110. In this embodiment, frame 110 is configured to wrap around both baffle 106 and packed bed 108. In FIG. 9, baffle 106 and packed bed 108 are coupled together according to another embodiment. In this embodiment, frame 110 does not wrap around baffle 106. Instead, frame 110 attaches to a back side 162 of baffle 106 and wraps around packed bed 108. In one embodiment, packed bed 108 is the same length as baffle 106. In another embodiment, packed bed 108 covers at least approximately 80% to approximately 95% of the surface area of back side 162. Of course a number of other embodiments may also be used to couple packed bed 108 to baffle 106. For example, packed bed 108 may be welded to baffle 106. Packed bed 108 may also be coupled to baffle 106 using removable and/or permanent fasteners, including without limitation, screws, rivets, snaps, locks, and/or inserts. Packed bed 108 may also be pivotably coupled to baffle 106 to allow for easy removal and/or inspection.

As shown in FIG. 10, the space between lower railing 104 and side 92 of hood 80 is often limited. Typically, this space is approximately 7.6 centimeters to approximately 12.7 centimeters. Since railings 102 and 104 are often approximately 3.5 centimeters to approximately 5.1 centimeters wide, separation cartridge 100, in an exemplary embodiment, is approximately 6.4 centimeters to 19.1 centimeters wide. Alternatively, separation cartridge 100 may be any suitable width depending on the particular design of hood 80.

In an exemplary embodiment, as shown in FIG. 10, separation cartridge 100 includes a front portion 158 and a back portion 160. Front portion 158 is configured to receive the exhaust. Back portion 160 is where the exhaust exits separation cartridge 100 and enters exhaust chamber 86. Separation cartridge 100 is configured so that back portion 160 protrudes from a plane 156 defined by upper and lower railings 102 and 104. In another embodiment, separation cartridge 100 may be configured so that front portion 158 protrudes from plane 156. Generally, front portion 158 comprises one separation medium and back portion 160 comprises another separation medium. In an exemplary embodiment, as shown in FIG. 10, back portion 160 comprises packed bed 108, which protrudes rearward from plane 156. In other embodiments, front portion 158-may include packed bed 108 and may be configured to be between railings 102 and 104 or protrude forward in front of railings 102 and 104. There are, of course, a number of various ways in which separation cartridge 100 may be configured so that either front portion 158 or back portion 160 protrudes from plane 156.

Separation cartridge 100 as shown in FIGS. 8-10 may include any of a number of alternative features and configurations as discussed previously or that otherwise may be desirable. For example, packed bed 108 shown in FIGS. 8-10 is flat. However, packed bed 108 may also be pleated.

Referring to FIG. 11, a cross-sectional top view of another exemplary embodiment of separation cartridge 100 is shown. In this embodiment, packed bed 108 is configured so that the pleats are positioned partially inside exit openings 120 of baffle 106. This configuration provides a number of advantages such as conserving space.

Referring to FIGS. 12 and 13, a cross-sectional top view of further exemplary embodiments of separation cartridge 100 are shown. In these embodiments, separation cartridge 100 includes a plurality of separation mediums arranged in various configurations. In an exemplary embodiment, shown in FIG. 12, separation cartridge 100 includes baffle 106, packed bed 108, and a mesh filter 144 positioned between baffle 106 and packed bed 108. Of course, FIG. 12 is only one embodiment and in other embodiments mesh filter 144 may be positioned in any of a number of positions. For example, mesh filter 144 may be placed in front of baffle 106 to provide an initial filter for air entering separation cartridge 100. Mesh filter 144 may also be positioned behind packed bed 108.

In another exemplary embodiment, shown in FIG. 13, multiple mesh filters may be used to separate entrained substances from a gas or air stream. In this embodiment, separation cartridge 100 includes baffle 106, packed bed 108, mesh filter 144, and mesh filter 146. Mesh filter 146 may be the same as mesh filter 144. However, another configuration for separation cartridge 100 is where mesh filter 144 is configured to filter out larger substances and mesh filter 146 is configured to filter out substances that are slightly or significantly smaller than those filtered out by mesh filter 144.

Mesh filters 144 and 146, shown in FIG. 13, are placed one right after the other. However, in other embodiments, mesh filters 144 and 146 may be positioned separate from one another. For example, mesh filter 144 and 146 may be positioned on opposing sides of baffle 106 or on opposing sides of packed bed 108.

Mesh filters 144 and 146 may be disposable or reusable. Mesh filters 144 and 146 are typically configured to be separate from baffle 106 and packed bed 108 so that when separation cartridge 100 is disassembled mesh filter 144 or 146 may be removed. Mesh filters 144 and 146 may be pleated or, as shown in FIGS. 12 and 13, flat.

Mesh filters 144 and 146 may be any of a number of different filters. For example, mesh filters 144 and 146 may include metal fibers such as aluminum, stainless steel, etc. or other organic or inorganic fibers such as ceramic. In addition, mesh filters 144 and 146 may be configured in a honeycomb pattern, overlaid layers of material, etc. The particular configuration of mesh filters 144 and 146 may depend on its position. For example, if mesh filter 144 is positioned in front of baffle 106, then it may be desirous to use a coarse filter to filter out larger substances. However, if mesh filter 144 is positioned after baffle 106, then it may be desirable to use a finer filter to filter out the substances that pass through baffle 106.

In further exemplary embodiments, multiple mesh filters and/or other separation mediums such as additional baffles, packed beds, etc. may be used in conjunction with or as a replacement for baffle 106, packed bed 108, mesh filter 144, etc. FIG. 25 shows a cross-sectional top view of an exemplary embodiment of separation cartridge 100 according to one of these embodiments. Separation cartridge 100, shown in FIG. 25 includes baffle 106, packed bed 108a, mesh filter 146, and packed bed 108b positioned in that order. Of course, other configurations of separation mediums may be used as well. Also, it should be understood, that certain configurations may be more or less desirable based on the applicable codes and regulations governing the particular use of disclosed separation mediums, cartridges, and apparatuses.

Referring to FIG. 14, a cross-sectional perspective view of another exemplary embodiment of separation cartridge 100 is shown. Separation cartridge 100 includes baffle 106 and packed bed 108, but, of course, may also include other separation mediums in any desirable configuration. In an exemplary embodiment, baffle 106 comprises a first plate 148 including a plurality of openings 152 and a second plate 150 including a plurality of openings 153. First and second plates 148 and 150 and are spaced apart perforated plates. The use of perforated plates may be advantageous in that the plates may be stamped in simple processes to form openings 152 and 153. In general, plates 148 and 150 are designed to divide the exhaust into multiple micro flows. As the exhaust flows through plates 148 and 150, entrained substances such as grease collides with plates 148 and 150 and drain into a grease trough in a manner analogous to that shown in FIG. 1C

Openings 152 and 153 may be configured in a variety of ways as shown in FIGS. 14-15 and 21-24. In some embodiments, openings 152 and 153 are round, as shown in FIGS. 14 and 21-23, or rectangular, as shown in FIGS. 15 and 24. Of course, other shapes may be used that are multilateral, round, half moon, slot, oblong, etc. Also, openings 152 and 153 may be straight, as shown in FIG. 14; round and collared, as shown in FIGS. 21 and 22; tapered, collared and round, as shown in FIG. 23; tapered, collared, and generally rectangular, as shown in FIG. 24; or, in any suitable shape or combination of shapes (e.g., frustoconical, etc.). Openings 152 and 153 may be formed into louvers to direct the air more efficiently and improve impaction of the grease on plates 148 and 150.

Advantageously, baffle 106, shown in FIG. 14, may provide a low pressure drop compared to other baffle designs. The pressure drop is a function of the open area of plates 148 and 150, the offset percentage of openings 152 and 153, and the velocity of the exhaust. In general, it is desirable to provide a high open area along with a high offset percentage to increase the efficiency of baffle 106 while still maintaining an acceptable pressure drop. The open area refers to the percentage of the area of plate 148 or 150 that is open for exhaust to pass through. The offset percentage refers to the alignment of openings 152 and 153 of plates 148 and 150. In particular, the offset percentage generally refers to the area of openings 152 (in other words, the area of the openings on the plate that the fluid stream initially passes through) that does not overlap with openings 153 (in other words, the area of the openings of the plate or plates that the fluid passes through after passing through the initial plate) expressed as a percentage of the total area of openings 152. Openings 152 and 153 overlap if exhaust passing through one set of openings is capable of passing through the next set of openings without being deflected. For example, in a separation apparatus that comprises two plates, 100% offset means that there is no overlap between the openings in the first plate and the openings in the second plate. Likewise, 50% offset means that 50% of the area of the openings in the first plate overlap with the openings in the second plate. In a separation apparatus that comprises three plates, the offset percentage may be used to refer to two adjacent plates or the combination of all three plates. The former situation is explained above. In the latter situation, the offset percentage refers to the area of the openings in the first plate through which the fluid passes that does not overlap with both the area of the openings in the second plate and the area of the openings in the third plate. In general, it is desirable to provide an offset percentage of approximately 100% so that all of the exhaust is deflected as it travels through plates 148 and 150.

In an exemplary embodiment, as shown in FIG. 14, plates 148 and 150 have substantially round openings 152 and 153 and have an open area of not more than approximately 40%, or, desirably, not more than approximately 30% with an offset percentage of approximately 100%, 90%, 80%, or 70%. In another exemplary embodiment as shown in FIG. 14, plates 148 and 150 have substantially round openings 152 and 153 and have an open area of approximately 10% to approximately 50%, or, desirably, of approximately 20% to approximately 40% coupled with an offset percentage of not less than approximately 40%, or desirably, not less than approximately 60%, or, suitably, not less than approximately 80%.

In an exemplary embodiment, as shown in FIG. 15, plates 148 and 150 have substantially rectangular openings 152 and 153 and have an open area of not more than approximately 60%, or, desirably, not more than approximately 50%, or desirably, not more than approximately 40% with an offset percentage of approximately 100%, 90%, 80%, or 70%. In another exemplary embodiment, as shown in FIG. 15, plates 148 and 150 have substantially rectangular openings 152 and 153 and have an open area of approximately 20% to approximately 60%, or, desirably, of approximately 30% to approximately 50% coupled with an offset percentage of not less than approximately 40%, or desirably, not less than approximately 60%, or, suitably, not less than approximately 80%.

Referring to FIGS. 14-15 and 21-24, baffle 106 including plates 148 and 150 may be configured in a number of ways. In an exemplary embodiment, as shown in FIG. 22, plates 148 and 150 are in an opposed relationship so that the offset percentage of openings 152 and 153 is approximately 100%. Also, the use of collared openings may enhance the deflection of the exhaust. In an exemplary embodiment, the collars on opposing plates 148 and 150 extend beyond one another so that the exhaust must be deflected at least a total of one hundred and eighty degrees for the exhaust to pass through plates 148 and 150. FIGS. 23(a) and (b) is similar to FIG. 22 except that in this embodiment, openings 152 and 153 are tapered.

In another exemplary embodiment, as shown in FIG. 24, openings 152 and 153 of plates 148 and 150, respectively; are generally rectangular, collared, and tapered. This configuration may be desirable because the user of rectangular openings typically allows for a greater open area at a given offset percentage than the use of substantially round openings.

In another exemplary embodiment, as shown in FIGS. 31 and 32, openings 152 and 153 of plates 148 and 150, respectively, are louvered. Openings 152 and 153 are configured so that plates 148 and 150 have an offset percentage of 100%. This is done by positioning plates 148 and 150 so that the louvers face each other in an opposing relationship with openings 152 and 153 being opposite the generally sloped surface 190 of the opposing louver. In this manner, the exhaust passing through openings 152 of plate 148 is deflected by surface 190 before passing through openings 153 of plate 150.

FIG. 18 is a graph showing the pressure drop in pascals versus the exhaust velocity in meters per second for plates 148 and 150 having various open areas. The graph shows that as percent open area increases, the pressure drop at a given velocity generally decreases. For example, a plate having an open area of 20% at a velocity of 5 meters per second has a pressure drop of approximately 575 pascals. However, a plate having an open area of 30% at a velocity of 5 meters per second has a pressure drop of approximately 225 pascals. Also, the graph shows that as the velocity increases, the pressure drop for a plate having a given open area also increases. For example, a plate having an open area of 30% has a pressure drop of approximately 225 pascals at a velocity of 5 meters per second and has a pressure drop of approximately 600 pascals at a velocity of 8 meters per second.

In addition to providing a low pressure drop, plates 148 and 150 may occupy less space then other designs. In one embodiment, plates 148 and 150 are configured to be spaced apart approximately 0.025 centimeters to approximately 4.8 centimeters, and, desirably, approximately 0.64 centimeters to approximately 2.6 centimeters. Of course, plates 148 and 150 may be spaced apart at widths more or less than those disclosed depending on the particular design of separation cartridge 100 and the ventilation system that it is used with. [0202] Although plates 148 and 150 are shown as part of separation cartridge 100, they may also be configured in a number of other ways. For example, in one embodiment a separation system may include plates 148 and 150 positioned in hood 80 at a distance from any other separation medium such as a baffle, mesh filter, or packed bed. In one embodiment, plates 148 and 150 may be built into hood 80 so that removing the separation apparatus would require the removal or substantial disassembly of hood 80. [0203] In another exemplary embodiment, a separation system such as a system that comprises hood 80 may be configured to include a single plate 148 alone or in combination with other separation mediums. For example, in an exemplary embodiment, plate 148 may be configured to be placed in front of baffle 106 as shown in FIG. 4. Of course, other embodiments and various comb:;nations of separation mediums may be used as desirable. [0204] In another exemplary embodiment, baffle 106 as shown in FIGS. 14-15 and 21-24 may include more than two plates 148 and 150. In one embodiment, baffle 106 may include three plates, each of which has an offset percentage of no less than approximately 50% in comparison to an adjacent plate and an overall offset percentage for baffle 106 of not less than approximately 90% or, desirably, not less than approximately 100%. Of course, other configurations may also be used such as four or more plates, as well as any of the open areas, offset percentages, configurations of openings, etc., described above in conjunction with FIGS. 14-15 and 21-24.

### EXAMPLES

The following examples are presented to illustrate the teachings and concepts described herein and to assist one of ordinary skill in making and using the same. The examples are not intended in any way to otherwise limit the scope of the invention.

### Example 1

Referring to FIG. 30, a cross-sectional side view of an exemplary embodiment of separation cartridge 100 is shown. Separation cartridge 100 includes baffle 106 and packed bed 108. Baffle 106 includes plates 148 and 150, which are configured to include substantially round, tapered, collared openings 152 and 153. Openings 152 and 153 are approximately 5 millimeters in diameter at their widest and 3.17 millimeters in diameter at their narrowest. Openings 152 in plate 148 are spaced apart approximately 6.35 millimeters (measured from the center of one opening 152 to the center of an adjacent opening 152). Likewise, openings 153 in plate 150 are spaced apart approximately 6.35 millimeters (measured from the center of one opening to the center of an adjacent opening). Plates 148 and 150 have an open area of approximately 20%. The collars surrounding each opening 152 and 153 extend substantially outward from plates 148 and 150 in a tapered manner approximately 3 millimeters. Plates 148 and 150 are positioned so that the collars on each plate protrude outwardly toward each other. The offset percentage for plates 148 and 150 is 100%. The distance between plates 148 and 150 is approximately 6.5 millimeters.

Packed bed 108 is configured to use a porous inorganic media 134 that is substantially spherical and has a diameter of approximately 1.5 millimeters. The pore size of each individual media particle is approximately 0.1 microns to approximately 10 microns. Packed bed 108 is pleated with an area multiplier of approximately 2. Also, the bed depth of packed bed 108 is 6.35 millimeters and the width of packed bed 108 is 35 millimeters. The perforated plates 196 used to make packed bed 108 are 0.5 millimeters thick and openings 198 are 0.83 millimeters in diameter. Also, perforated plates 196 have an open area of approximately 25%.

### Example 2

An exemplary embodiment of plates 148 and 150 is tested to determine the pressure drop. En this embodiment, plates 148 and 150 are spaced apart approximately 0.625 centimeters. Plates 148 and 150 have approximately 0.238 centimeter straight holes and 20% open area and are similar to plates 148 and 150 shown in FIG. 14. FIG. 16 shows a graph of pressure drop in pascals versus the exhaust velocity in centimeters per second for plates 148 and 150 described in this example. A typical exhaust velocity for a hood is approximately 200 centimeters per second. As shown in FIG. 16, the pressure drop ranges from approximately 40 pascals at 80 cm/s to approximately 200 pascals at 180 cm/s. The pressure drop is not linear but is instead a slightly concave curve.

### Example 3

Two exemplary embodiments of baffle 106, both of which include plates 148 and 150, and a baffle similar to that shown in FIG. 5 are tested to determine the separation efficiency of each one. FIG. 17 is a graph of the results of the test. The baffle that is similar to FIG. 5 has a pressure drop that is approximately 325 pascals and is referred to on the accompanying graph as Baffle C. The exhaust flow is approximately 775 L/(s·m) (i.e., liters per (second·linear meter of hood)). The face velocity is approximately 200 centimeters per second.

The first exemplary embodiment of baffle 106 is referred to as Baffle A in FIG. 17. Baffle A includes two perforated plates that are spaced apart approximately 0.625 centimeters. Each of the perforated plates has an open area of approximately 23%. Also, the openings in the plates are substantially round with a diameter of approximately 0.24 centimeters. The spacing of the openings is substantially uniform and is approximately 0.48 centimeters from the center of one opening to the center of an adjacent opening. Also, the pressure drop across this embodiment is approximately 150 pascals at a velocity of 200 centimeters per second.

The second exemplary embodiment of baffle 106 is referred to as Baffle B in FIG. 17. Baffle B includes two perforated plates that are spaced apart approximately 0.625 centimeters. Each of the perforated plates has an open area of approximately 26%. Also, the openings are substantially round with a diameter of approximately 0.08 centimeters. The spacing of the openings is substantially uniform and is approximately 0.16 centimeters from the center of one opening to the center of an adjacent opening. Also, the pressure drop across this embodiment is approximately 75 pascals at a velocity of 200 centimeters per second.

The graph shows that for substances between three and ten microns in size, Baffle A is substantially more efficient than Baffle B, which is more efficient than Baffle C. Specifically, for substances that are approximately 8 microns in size; Baffle A removes approximately 87%; Baffle B removes approximately 68%; and Baffle C removes approximately 62%.

### Example 4

Referring to FIG. 27, a graph is shown of the separation efficiency of an exemplary embodiment of packed bed 108 that includes porous media, which is referred to in the graph as “Porous Media Bed” and another exemplary embodiment of packed bed 108 that includes solid media, which is referred to in the graph as “Solid Media Bed.” The characteristics of both the Porous Media Bed and the Solid Media Bed are as follows. The bed depth of both beds is approximately 0.75 centimeters. The size of the porous and solid media are substantially spherical in shape and have a diameter of approximately 0.9 millimeters to approximately 1.0 millimeters. The velocity of the air flowing into the beds is approximately 120 centimeters per second.

As shown in the graph, the separation efficiency of porous media versus solid media for a packed bed is similar with the packed bed being somewhat more efficient. For substances smaller than one micron, the porous media is more efficient than the solid media (e.g., for 0.9 micron substances, the porous media removes approximately 12.5% and the solid media removes approximately 0%. However, for approximately 3.3 micron substances, both the solid and porous media are approximately 98% efficient.

### Example 5

Referring to FIG. 28, a graph of the media size versus pressure drop is shown for an exemplary embodiment of packed bed 108. In this example, packed bed 108 is approximately 2.54 centimeters wide and the velocity of the exhaust is approximately 3.7 meters per second. The media is substantially spherical.

As shown in the graph, the general trend is that for larger media sizes the pressure drop is smaller and as the media size decreases the pressure drop increases. The Y axis of the graph shows the media size in millimeters in ascending order. The X axis of the graph shows the pressure drop in pascals beginning with four hundred pascals as the origin. The shape of the curve shown in the graph is concave with the high point corresponding to the largest media size and smallest pressure drop and the low point corresponding to the smallest media size and highest pressure drop. For example, for a media size of approximately 2 millimeters, the pressure drop is approximately 425 pascals. Also, for a media size of approximately 1.2 millimeters, the pressure drop is approximately 790 pascals. For a media size of approximately 0.7 millimeters, the pressure drop is approximately 1600 pascals.

### Example 6

FIG. 29 shows a graph of the pressure drop in pascals versus the exhaust velocity in centimeters per second for an exemplary embodiment of packed bed 108 that is flat and an exemplary embodiment of packed bed 108 that is pleated. The pleated bed has a 2.2 multiplier versus the flat bed. Also, both embodiments use 1.3 millimeter substantially spherical media. Also, shown in the graph is the pressure drop ratio of the flat bed over the pleated bed. The pressure drop ratio is the pressure drop across the flat bed divided by the pressure drop across the pleated bed. As shown in the graph, the pressure drop across the flat bed for a given exhaust velocity is greater than the pressure drop across a pleated bed for the same exhaust velocity. This is because the media velocity (i.e., the velocity of the air as it passes through the media as opposed to the face velocity) is substantially different for a packed bed versus a pleated bed. The media velocity of the exhaust through the flat bed is greater than that of the pleated bed because there is much less area for air to flow through in a flat bed.

### Example 7

An exemplary embodiment of a separation cartridge 100 may be made using the following procedure. Initially, packed bed 108 is formed using two perforated sheets of stainless steel. The openings are 0.635 centimeter squares and each sheet is approximately 50% open. Each sheet is formed into rectangular frame shapes that when put together form a flat packed bed 108. In order to accomplish this, one of the frame shapes is configured to fit into the other frame shape. Aluminum wire cloth is cut to fit inside of each of the frame shapes. The aluminum mesh is fixed to the outer edge of the frame shapes to prevent packed bed 108 media from leaking out of the openings (i.e., to contain the media). Accordingly, the wire cloth is configured to have openings that are smaller than the size of the media. The next step is to pack one of the frame shapes with media such as porous or solid inorganic beads (e.g., ceramic beads). The frame shape is packed with enough beads that when the frame shapes are fit together the media is tightly packed. Thus, packed bed 108 is held together by the frame shapes in a tight unit.

The baffle 106 is formed by cutting thin gauge stainless steel sheet metal into flat rectangular shapes, which are then bent to form the deflectors. The ends of the deflectors are then spot welded to two other rectangular pieces of stainless steel sheet metal.

The baffle 106 and packed bed 108 are assembled into separation cartridge 100 as follows. Initially, four pieces of stainless steel sheet metal are cut to the appropriate size (i.e., the size necessary to form a relatively snug frame around baffle 106 and packed bed 108). The pieces of sheet metal are then formed into a U-shape. The separation cartridge is assembled by pop riveting baffle 106 and packed bed 108 to the four pieces. The four pieces of sheet metal when assembled from frame 110.

### Example 8

Another exemplary embodiment of separation cartridge 100 may be made using the following procedure. Separation cartridge 100 includes baffle 106 and packed bed 108. Referring to FIG. 19, end caps 180 are machined out of flat 0.625 centimeter thick aluminum plate leaving trenches 182 to secure the pleated portion 184 of packed bed 108. Sides 186 and 188 are made out of flat 0.318 centimeter thick aluminum plate to hold end caps 180 together. Pleated portion 184 is made using aluminum perforated sheet metal that is 0.0762 centimeters thick and has 0.476 centimeter openings 198 with the sheet being 50% open. Aluminum wire cloth is cut slightly larger than the aluminum sheet so that the wire cloth can be attached to the sheet by wrapping approximately 0.625 centimeters over each side. The aluminum wire cloth has openings that are smaller than the media in order to prevent the media from leaking out of openings 198. After the wire cloth is coupled to the perforated sheet, it was formed into a rounded pleated shape using a punch and die. The pleated portion is assembled by coupling it to end caps 180. Media in the form of porous inorganic beads (e.g., ceramic beads, etc.) is then poured into pleated portion 184 through a filler opening in one of end caps 180 until all of the space has been filled. Pleated portion 184 is tapped periodically during the filling process to ensure that the media is tightly settled. The filler opening is tapped so that a setscrew can be placed in the opening to seal it after the bed has been filled. The width of the pleated portion 184 is approximately 0.635 centimeters.

Baffle 106 is formed using plates 148 and 150. Plates 148 and 150 are formed by cutting two sheets of perforated sheet metal to the appropriate size. The plates are then slid into place on guide rails 190 in end caps 180. Sides 186 and 188 are then put in place to hold plates 148 and 150 in place. If plates 148 and 150 need to removed for cleaning or some other reason, sides 186 and 188 can be removed so that plates 148 and 150 slide out of end caps 180. FIG. 33 shows separation cartridge 100 after it has been assembled.

### Example 9

Another exemplary embodiment of separation cartridge 100 may be made using the following procedure. In this embodiment, baffle 106 is a conventional commercially available baffle used in kitchen hoods. Conventional baffle 106 includes deflectors configured to deflect the air as it travels through the baffle, thus separating entrained substances such as grease from the gas or air stream. In this embodiment, packed bed 108 is coupled to baffle 106.

Packed bed 108 is made according to the procedure of Example 7. Baffle 106 and packed bed 108 are coupled together using two pieces of stainless steel sheet metal in a manner similar to that disclosed in relation to FIG. 9. Once the pieces of sheet metal are cut to the appropriate size, they are bent using a brake press. The pieces are then coupled to baffle 106 using pop rivets. Packed bed 108 slides between the two pieces of bent sheet metal in a removable manner. Thus, if packed bed 108 needs to be cleaned it may be easily removed from separation cartridge 100.

As utilized herein, the following terms shall include the following meanings in addition to and/or in conjunction with their plain and ordinary meaning to one of ordinary skill in the art to which the subject matter of this disclosure pertains. “Separation cartridge” means any module designed to be inserted into a larger apparatus that is designed to separate an entrained substance from a fluid stream. “Separation medium” means any device or apparatus that is configured to separate an entrained substance from a fluid stream. “Baffle” means any device or apparatus used to change the direction of flow or the velocity of a fluid.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art that these terms are intended to allow a description of certain features described and claimed without restricting the scope of these features to the precise numerical ranges, etc. provided. Accordingly, these terms should be interpreted as indicating that insubstantial or inconsequential modifications or alterations of the subject matter described and claimed are considered to be within the scope of the invention as recited in the appended claims.

The construction and arrangement of the elements of the separation apparatus as shown in the embodiments is illustrative only. Although only a few embodiments of the present inventions have been described in detail in this disclosure, those of ordinary skill who review this disclosure will readily appreciate that many modifications are possible without materially departing from the novel teachings and advantages of the subject matter recited in the claims. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the embodiments without departing from the scope of the present invention as expressed in the appended claims.

The following material was added with this application.

Referring to FIGS. 34-37, another embodiment of baffle 106 is shown. In this embodiment, baffle 106 comprises a frame 220 which encloses and/or holds together a plurality of deflectors 202 which have substantially S shaped cross section. When baffle 106 is laid flat in a horizontal plane, as shown in FIGS. 34-37, each S shaped deflector 202 may be referred to as including a top curve 210 and a bottom curve 212. Each deflector 202 includes ends 206 and 208. End 206 is adjacent to top curve 210 and partially defines entry opening 118 where exhaust 112 enters baffle 106. End 208 is adjacent to bottom curve 212 and partially defines exit opening 120 where exhaust 112 exits baffle 106. Deflectors 202 are arranged so that adjacent deflectors 202 overlap. For example, as shown in FIGS. 34-37, top curve 210 of one deflector 202 is positioned over end 208 of an adjacent deflector 202. Likewise, bottom curve 212 of one deflector 202 is positioned below end 206 of an adjacent deflector 202. In this manner, deflectors 202 may overlap to provide a substantially S shaped pathway 214 which exhaust 112, follows as it passes through baffle 106.

In one embodiment, frame 220 comprises openings 222 which allow substances such as grease, to drain into trough 82 in hood 80, for example. Frame 220 is coupled to deflectors 202 using rivets 226. Rivets 226 engage deflectors 202 at openings 224. Of course, it should be understood that in other embodiments frame 220 may be coupled to deflectors 202 in a variety of suitable ways (e.g., spot welding, tabs on deflectors 202 that correspond to slots in frame 220, etc.). Also, baffle 106 may comprise handles 204 which can be used to position baffle 106 between railings 102 and 104. Baffle 106 may also include a number of other additional desirable features.

In one embodiment, ends 206 and 208 are rounded. As shown in FIGS. 34-37, ends 206 and 208 may be rounded by bending deflector 202 at ends 206 and/or 208 in a small loop. While not wishing to be bound by theory, it is thought that by rounding ends 206 and 208 there are smaller and/or fewer eddies and less turbulence, which may result in a smaller pressure drop.

In another embodiment, end 206 includes a linear portion 216, and end 208 is substantially continually curved. As shown in FIG. 36, linear portion 216 begins at a point where the curvature from top curve 210 ends and extends to the rounded portion of end 206. However, end 208 is substantially continually curved so that bottom curve 212 naturally flows into end 208. Also, it should be noted that end. 208 curves beyond a plane 218 that is normal to the center of top curve 210. Thus, while not wishing to be bound by theory, it is thought that end 208 forces exhaust 112 against top curve 210 in a more forceful manner than if end 208 was not curved as shown, thereby increasing the efficiency at which substances in exhaust 112 are captured.

In another embodiment, top curve 210 and bottom curve 212 may comprise the same or varying radiuses. For example, the radius of top curve 210 may vary from approximately 3 mm to approximately 15 mm, desirably from approximately 6 mm to approximately 9 mm, or suitably from approximately 7 mm to approximately 8 mm. In another embodiment, the distance between the center of top portions 210 of adjacent deflectors may be between approximately 5 mm and approximately 100 mm, or, desirably, between approximately 10 mm and approximately 50 mm, or, suitably, between approximately 15 mm and approximately 30 mm. In still another embodiment, the width of baffle 106 may be 10 mm to 30 mm. In this embodiment, baffle 106 may be combined with packed bed 108 in separation cartridge 100. Of course, in another embodiment, baffle 106 may be configured to be a suitable size to fit between upper and lower railings 102 and 104. In another embodiment, baffle 106 may be used alone without another separation medium. In another embodiment, baffle 106 may be combined with any of a number of other separation mediums to form separation cartridge 100. In still another embodiment, baffle 106 may be used in combination with another separation medium and be positioned adjacent to or distant from the other separation medium in the ventilation system.

### Example 10

Referring to FIG. 38, a graph is shown of the filtration efficiency versus particle size for various embodiments of separation apparatuses as well as for a conventional baffle at two different air flow rates. In particular, the fractional efficiency of baffle 106 (all references to baffle 106 in this example refer to the embodiment shown in FIGS. 34-37) alone and in combination with packed bed 108 are shown. The procedure used to obtain the data in FIG. 38 is as follows.

A standard size 1.22 meter hood was used to acquire the efficiency data. The hood is approximately 41 cm between rails 102 and 104 and is configured to hold three approximately 41 cm by approximately 41 cm baffles. 4.57 meters of straight, 40.64 cm, round duct connects the hood to an exhaust fan. The exhaust fan is a standard exhaust fan available from Loren Cook Co., Springfield, Mo. 65808. The flow of exhaust through the hood is selectively adjustable to a number of suitable exhaust flows.

The first step in performing the efficiency testing is to set the fan speed to achieve the desired flow rate of exhaust 112. The flow rate of exhaust 112 may be calculated by measuring the velocity in the duct with an appropriate measuring device such as a pivot tube, or anemometer and then multiplying that velocity by the known cross sectional area of the duct.

In this example, oleic acid is used as an artificial emission material to introduce into exhaust 112. An atomizer is positioned below an opening in the hood where the baffles sit. An optical particle counter, available from Pacific Scientific Instruments, 481 California Ave., Grants Pass, Oreg. 97526, is used to size and count the oleic acid particles. An appropriate sized sampling nozzle to obtain isokinetic sampling conditions is placed in the center of the duct, eight duct diameters downstream from the hood. A 50× diluter is attached to the particle counter so the concentration of particles passing through the conter is below the maximum concentration of 1,000,000 particles per 28.3 Liters. The particle counter has eight channels or bins for different size particles. Although the optical particle counter can sense particles between 0.3 and 20 microns, the bins are selected to be within the range of 0.9 to 10 microns.

Initial samples are taken of the particle count in exhaust 112 to obtain a baseline without a separation apparatus in place. The counter samples the particles for one minute five times to obtain an average. The various separation apparatuses being tested are then placed in the hood without changing the atomizer. The fan is adjusted to obtain the same flow rate at which the baseline was obtained. Once the flow rate is adjusted, the counter may sample another five times to obtain an average. This procedure is performed at two flow rates: 387 L/s*m and 619 L/s*m. The baseline is then compared to the particle counts with various baffles in place to obtain a percentage efficiency based on the eight different particle sizes identified by the 8 bins in the particle counter. FIG. 38 can then be established using this data.

In FIG. 38, the dashed lines refer to data obtained at a flow rate of 619 L/s*m and the solid lines refer to data obtained at a flow rate of 387 L/s*m. One trend that can be seen in the graph is that the higher flow rate generally results in higher efficiencies for all of the tested items. The conventional baffles failed to realize efficiencies that were much above L 50% for 10 micron particles and had 0% efficiency for particles below 3 microns. By contrast, baffle 106, realized an efficiency of about 85% at 387 L/s*m and 95% at 619 L/s*m for 10 micron particles. Also, the efficiency of baffle 106 for 5 micron particles was 60% at 387 L/s*m and 80% at 619 L/s*m. The efficiency of baffle 106 was 0% for particles smaller than 2.5 microns at the lower flow rate and was 30% for 2 micron particles at the higher flow rate. Baffle 106 combined with packed bed 108 provided even greater efficiency. Specifically, at the lower flow rate, the addition of packed bed 108 increased the efficiency overall by approximately 10-20% and, at the higher flow rate, the addition of packed bed 108 increased the efficiency overall by approximately 4-5% for particles above 7 microns and 10-20% for particles below 7 microns.

The pressure drop over the conventional baffle is 149 pascals and 50 pascals for the high and low flow rates, respectively. The pressure drop over baffle 106 by itself is 323 pascals and 124 pascals for the high and low flow rates, respectively. The pressure drop over the combination of baffle 106 and packed bed 108 is 672 pascals and 348 pascals for the high and low flow rates, respectively.

### Illustrative Embodiments

The following material is from U.S. Provisional Application No. 60/272,044, filed on Mar. 1, 2001.

1. A method for substantially separating one or more oleo substances from a fluid comprising the steps of: (a) placing a composition of inorganic, porous particles into contact with said fluid moving relative to the particles; and (b) allowing the oleo substance to agglomerate on at least a portion of said inorganic particles as the vapor composition passes at least substantially through said composition of inorganic porous particles.

2. A method according to paragraph 1, wherein said inorganic porous particles are arranged to form a network suitable for filtering the one or more oleo substances from the moving fluid.

3. A method according to paragraph 1, wherein the oleo substance agglomerates within at least a portion of the pores of the inorganic, porous particles.

4. A method according to paragraph 3, wherein during step (b), the drop in pressure of the fluid passing through said composition remains substantially constant for a period of time.

5. A method according to paragraph 3, further comprising isolating said particles from the fluid after agglomeration occurs.

6. A method according to paragraph 5, further comprising substantially separating the oleo substance from the inorganic, porous particles.

7. A method according to paragraph 6, wherein after said separation step, said inorganic, porous particle again is subject to steps (a) and (b).

8. A method according to paragraph 6, wherein said separation step is selected from the group consisting of heat treating the particles, solvent extraction, and a detergent washing step.

9. A method according to paragraph 1, wherein the inorganic, porous particle is on the order of 0.25-4 mm.

10. A method according to paragraph 1, wherein the inorganic, porous particle is pellet or pellet-like in shape.

11. A filtration media comprising a packed bed of inorganic, porous particles arranged to separate one or more oleo substances from a moving fluids wherein said particles attract said one or more oleo substances.

12. A filtration media according to paragraph 11, wherein said particles relinquish substantially all of said one or more oleo substances upon subjecting the particles to a separation step, and wherein the particle maintains the ability to attract said one or more oleo substances after said separation step occurs.

13. A filtration media according to paragraph 12, wherein the separation step is selected from the group consisting of heat treatment, solvent extraction, and a detergent washing step.

14. A filtration media according to paragraph 11, wherein each of the particles is on the order of 0.25-4 mm.

16. A filtration media according to paragraph 11, wherein each of the particles is a pellet or pellet-like in shape.

17. A system for substantially separating one or more oleo substances from a moving fluid comprising the filtration media of paragraph 11, a first duct positioned in relationship with the packed bed of porous particles, wherein the moving fluid passes through said duct before passing through said network.

18. A system according to paragraph 17, further comprising a housing for holding said one or more oleo substances in a liquid or solid state, wherein upon heating said housing, said one or more oleo substances in the liquid or the solid state vaporizes or forms droplets, and wherein the housing is positioned such that substantially all of the vapor enters the first duct.

19. A system according to paragraph 18, further comprising a catalytic converter, wherein the fluid passes through the catalytic converter after passing through the packed bed of porous particles.

20. A system according to paragraph 19, further comprising a second duct or an extension of the first duct which joins the catalytic converter and the packed bed of porous particles.

21. A method according to paragraph 1, wherein the oleo substance is a fat or oil and the moving fluid is air.

22. A filtration media according to paragraph 11, wherein the particles are ceramic.

23. A system according to paragraph 17, wherein the housing is a deep fat fryer or a griddle.

24. A method for substantially separating a hydrophilic substance from a fluid comprising the steps of: (a) placing a composition of inorganic, porous particles into contact with said fluid moving relative to the particles; and (b) allowing the hydrophilic substance to agglomerate on at least a portion of said inorganic particles as the vapor composition passes at least substantially through said composition of inorganic porous particles, wherein said porous particles contain hydrophilic surfaces within the porous area thereof, and wherein said hydrophilic substance passes through a first filtration apparatus before contacting the porous particles.

The following material is from U.S. patent application Ser. Nos. 10/076,144 and 10/363,849 and International Application No. PCT/US02/05753 the earliest of which was filed on Feb. 15, 2002.

1D. A method for substantially separating one or more filtrate substances from a fluid comprising the steps of: (a) placing inorganic, porous particles into contact with said fluid moving relative to the particles; and (b) allowing or causing the filtrate substance(s) to collect within at least a portion of said porous, inorganic particles as the fluid passes at least substantially through said inorganic, porous particles.

2D. A method according to paragraph 1D, wherein said inorganic, porous particles, are arranged to form a network suitable for filtering one or more filtrate substances from the fluid.

3D. A method according to paragraph 2D, further comprising isolating said inorganic, porous particles from the fluid after collection occurs.

4D. A method according to paragraph 3D, further comprising substantially removing or cleaning the filtrate substance from the inorganic, porous particles.

5D. A method according to paragraph 4D, wherein after said separation step, said inorganic, porous particles again are subject to steps (a) and (b).

6D. A method according to paragraph 5D, wherein said separation step is selected from the group consisting of heat treatment, solvent extraction, detergent washing, centrifugal separation step and combinations thereof.

7D. A method according to paragraph 1D, wherein a dimension of a single inorganic, porous particle is on the order of 0.1-4 mm.

8D. A method according to paragraph 1D, wherein a dimension of a single inorganic, porous particle is on the order of greater than 4 to 100 mm.

9D. A method according to paragraph 1D, wherein the filtrate substance is an oleo substance and the moving fluid is air.

10D. A method according to paragraph 1D, wherein the inorganic, porous particles are spherical, pellet or pellet-like in shape or a combination thereof.

11D. A method for substantially separating one or more filtrate substances from a fluid comprising the steps of: (a) placing a bed of inorganic, porous particles into contact with said fluid moving relative to the particles; and (b) allowing or causing the one or more filtrate substances to collect within at least a portion of said inorganic, porous particles as the fluid passes at least substantially through said bed of inorganic, porous particles.

12D. A method according to paragraph 11D, wherein during step (b), the drop in pressure of the fluid passing through said bed remains substantially constant for a period of time.

13D. A method according to paragraph 1D, wherein the one or more filtrate substances include a hydrophilic substance and the inorganic, porous particles contain hydrophilic surfaces within the porous area thereof.

14D. A method according to paragraph 13D, wherein the surfaces of the inorganic, porous particles and pores are coated or impregnated with a biocidal agent.

15D. A method according to paragraph 1D, wherein the surfaces of the pores within the inorganic, porous particles are coated with a catalyst.

16D. A method according to paragraph 1D, wherein the surfaces of the pores within the inorganic, porous particles are coated with a reactive chemical.

17D. A filtration media comprising a bed of inorganic, porous particles arranged to separate one or more filtrate substances from a moving fluid wherein said particles absorb said one or more filtrate substances.

18D. A filtration media according to paragraph 17D, wherein said inorganic, porous particles relinquish substantially all of said one or more filtrate substances upon subjecting the inorganic, porous particles to a separation step, and wherein the inorganic, porous particles maintain the ability to absorb said one or more filtrate substances after said separation step occurs.

19D. A filtration media according to paragraph 18D, wherein the separation step is selected from the group consisting of heat treatment, solvent extraction, detergent washing, centrifugal separation and combinations thereof.

20D. A filtration media according to paragraph 17D, wherein a dimension of a single inorganic, porous particle is on the order of 0.1-4 mm.

21D. A filtration media according to paragraph 17D, wherein a dimension of a single inorganic, porous particle is on the order of greater than 4 to 100 mm.

12D. A filtration media according to paragraph 17D, wherein the inorganic, porous particles are spherical, pellet or pellet-like in shape or a combination thereof.

23D. A filtration media according to paragraph 17D, wherein the one or more filtrate substances include one or more oleo substances.

24D. A filtration media according to paragraph 17D, wherein the inorganic, porous particles are ceramic.

25D. A filtration media according to paragraph 17D, wherein the inorganic, porous particles are metal.

26D. An apparatus for substantially separating one or more filtrate substances from a moving fluid comprising the filtration media of paragraph 17D, a duct positioned in relationship with the packed bed of porous particles, wherein the moving fluid passes through said duct before passing through said bed.

27D. An apparatus according to paragraph 26D, further comprising a catalytic reactor, wherein the fluid passes through the catalytic reactor after passing through the packed bed.

28D. An apparatus according to paragraph 27D, further comprising a second duct or an extension of the first duct which joins the catalytic reactor and the packed bed.

29D. A method for substantially separating one or more filtrate substances from a fluid, comprising fluidizing a group of inorganic porous particles with said fluid and allowing said filtrate substances within said particles.

The following material was filed as a preliminary amendment with U.S. patent application Ser. No. 10/363,849 on Mar. 14, 2003.

30D. A system for substantially separating at least one filtrate substance from a fluid comprising: a bed of inorganic, porous particles; and a duct for conveying the fluid including said at least one filtrate substance into contact with the bed to produce relative movement between the fluid and the bed of inorganic, porous particles; wherein the bed of inorganic, porous particles defines interstices between at least some of the inorganic, porous particles, and wherein each inorganic, porous particle includes an exterior surface and a plurality of channels that open onto said exterior surface and define internal surfaces for collecting the at least one filtrate substance from the exterior surface to mitigate collection of filtrate substance within the interstices.

31D. The system of paragraph 30D, wherein a dimension of a single inorganic, porous particle is about 0.1 mm to about 4 mm.

32D. The system of paragraph 30D, wherein a dimension of a single inorganic, porous particle is about 4 mm to about 100 mm.

33D. The system of paragraph 30D, wherein the filtrate substance comprises an oleo substance and the fluid comprises air.

34D. The system of paragraph 30D, wherein the inorganic, porous particles are spherical, pellet or pellet-like in shape, ring shaped, saddle shaped or a combination thereof.

35D. The system of paragraph 30D, wherein the at least one filtrate substance comprises a hydrous substance and the pores of the inorganic, porous particles include hydrophilic surfaces.

36D. The system of paragraph 30D, wherein at least one of the exterior and internal surfaces of the inorganic, porous particles include a biocidal agent.

37D. The system of paragraph 36D, wherein the biocidal agent comprises a silver containing biocidal agent.

38D. The system of paragraph 30D, wherein the internal surfaces of the inorganic, porous particles include a catalyst.

39D. The system of paragraph 30D, wherein the internal surfaces of the inorganic, porous particles include a reactive chemical.

40D. The system of paragraph 30D, wherein the channels have a mean size of about 0.01 micron to about 100 micron.

41D. The system of paragraph 30D, wherein the channels have a mean size of about 0.01 micron to about 10 micron.

42D. The system of paragraph 30D, wherein the porous, inorganic particles are about 15% porous to about 70% porous.

43D. The system of paragraph 30D, wherein the inorganic, porous particles are at least partially composed of transition metal oxide, zircon, zirconia, titania, silica, alumina, alumina-silica, kaolin, bentonite, montmorillonite, iron, or a combination thereof.

44D. The system of paragraph 30D, wherein the bed has a length, a width and a depth.

45D. The system of paragraph 30D, wherein the rate of collection of the filtrate substance within the channels is greater than the rate that the filtrate substance collects within the interstices.

46D. The system of paragraph 30D, wherein the filtrate substance is collected within the channels by capillary action.

47D. A method for substantially separating at least one filtrate substance from a fluid comprising: contacting the fluid with a bed of inorganic, porous particles to produce relative motion between said fluid and the bed, wherein the bed of inorganic, porous particles includes a plurality of particles defining interstices therebetween, and wherein each inorganic, porous particle includes an exterior surface and a plurality of channels that open onto said exterior surface and define internal surfaces for collecting the at least one filtrate substance from the exterior surface, whereby the at least one filtrate substance collects on the exterior surface of the inorganic, porous particles and the at least one filtrate substance is drawn within the channels to mitigate collection of the filtrate substance within the interstices.

48D. The method of paragraph 47D, wherein the drop in pressure of the fluid passing through said bed remains substantially constant for a period of time.

49D. The method of paragraph 47D, further comprising isolating said inorganic, porous particles from the fluid after collection occurs.

50D. The method of paragraph 47D, further comprising substantially separating the at least one filtrate substance from the inorganic, porous particles.

51D. The method of paragraph 50D, wherein said separation comprises heat treatment, solvent extraction, detergent washing, centrifugal separation or a combination thereof.

52D. The method of paragraph 50D, wherein after said separation step, said inorganic, porous particles are again placed into contact with said fluid moving relative to the inorganic, porous particles.

53D. A filtration media comprising a three-dimensional bed of inorganic, porous particles arranged to separate oleo material from a moving fluid, wherein the bed of inorganic, porous particles defines interstices between at least some of the inorganic, porous particles, and wherein each inorganic, porous particle includes an exterior surface and a plurality of pores that open onto said exterior surface and define internal surfaces for collecting the oleo material from the, exterior surface to mitigate collection of oleo material within the interstices and wherein said particles and pores include an oleophilic surface that draws the oleo material within the pores from the exterior surface of the particles.

54D. The filtration media of paragraph 53D, wherein said inorganic, porous particles are capable of relinquishing substantially all of said oleo material upon subjecting the inorganic, porous particles to a separation step, and wherein the inorganic, porous particles maintain the ability to collect the oleo material after said separation step occurs.

55D. The filtration media of paragraph 54D, wherein the separation step is selected from the group consisting of heat treatment, solvent extraction, detergent washing, centrifugal separation and combinations thereof.

56D. The filtration media of paragraph 53D, wherein a dimension of a single inorganic, porous particle is about 0.25 mm to about 4 mm, and the pores have a mean cross-sectional dimension of no less than about 0.1 micron.

57D. The filtration media of paragraph 53D, wherein a dimension of a single inorganic, porous particle is greater than about 4 mm.

58D. The filtration media of paragraph 53D, wherein the inorganic, porous particles are spherical, pellet or pellet-like in shape, ring shaped, saddle shaped or a combination thereof.

59D. The filtration media of paragraph 53D, wherein the oleo material is in the fluid as an aerosol.

60D. The filtration media of paragraph 53D, wherein the inorganic, porous particles comprise a ceramic material.

61D. The filtration media of paragraph 53D, wherein the inorganic, porous particles comprise a metal.

62D. An apparatus for substantially separating at least one filtrate substance from a moving fluid, comprising the filtration media of paragraph 53D, a duct positioned in relationship with the bed of porous particles, wherein the moving fluid passes through said duct before passing through said bed.

63D. The apparatus of paragraph 62D, further comprising a catalytic reactor, wherein the fluid passes through the catalytic reactor after passing through the bed. 64D. The apparatus of paragraph 63D, further comprising a second duct or an extension of the first duct which joins the catalytic reactor and the bed.

The following material is from U.S. patent application Ser. No. 10/632,805, filed on Aug. 4, 2003.

1E. A separation cartridge comprising: a first separation medium; a second separation medium positioned adjacent to the first separation medium; and a frame configured to hold the first and second separation mediums; wherein the separation cartridge is configured to separate one or more entrained substances from a gas stream in a hood system.

2E. The separation cartridge of paragraph 1E wherein the first and second separation mediums are selected from a group consisting of a baffle, a packed bed, a mesh filter, and combinations thereof.

3E. The separation cartridge of paragraph 2E wherein at least one of the separation mediums is a packed bed.

4E. The separation cartridge of paragraph 3E wherein the packed bed is pleated.

5E. The separation cartridge of paragraph 3E wherein the packed bed comprises inorganic media.

6E. The separation cartridge of paragraph 5E wherein a mean dimension of a particle in the media approximately 0.1 millimeters to approximately 100 millimeters.

7E. The separation cartridge of paragraph 5E wherein the media includes particles comprising a plurality of sizes.

8E. The separation cartridge of paragraph 5E wherein the media is substantially solid.

9E. The separation cartridge of paragraph 5E wherein the media is substantially porous and comprises an exterior surface and a plurality of channels that open onto the exterior surface and define internal surfaces.

10E. The separation cartridge of paragraph 9E wherein the channels comprise a mean size of approximately 0.01 microns to approximately 10 microns.

11E. The separation cartridge of paragraph 9E wherein the porous inorganic particles are approximately 15% porous to approximately 95% porous.

12E. The separation cartridge of paragraph 11E wherein the porous inorganic particles are approximately 30% porous to approximately 70% porous.

13E. The separation cartridge of paragraph 1E wherein the first separation medium comprises a plurality of entry openings and a plurality of exit openings, the entry and exit openings being at least substantially offset so that at least a substantial portion of a gas passing through the entry openings is deflected before passing through the exit openings.

14E. The separation cartridge of paragraph 1E wherein a primary mechanism used by the first separation medium to separate the entrained substances from a gas stream is impaction.

15E. The separation cartridge of paragraph 14E wherein a mechanism or mechanisms used by the second separation medium to separate the entrained substances from a gas stream is selected from a group consisting of impaction, absorption, adsorption, sieving, and combinations thereof.

16E. The separation cartridge of paragraph 1E wherein the first separation medium is in contact with the second separation medium.

17E. The separation cartridge of paragraph 1E wherein the separation cartridge is approximately 2.5 centimeters to approximately 6.4 centimeters wide.

18E. The separation cartridge of paragraph 17E wherein the separation cartridge is approximately 3.8 centimeters to approximately 4.8 centimeters wide.

19E. The separation cartridge of paragraph 1E wherein the hood system is a kitchen hood system.

20E. The separation cartridge of paragraph 1E further comprising a third separation medium.

21E. The separation cartridge of paragraph 1E wherein one or both of the first and second separation mediums is configured to be easily removed from the frame.

22E. The separation cartridge of paragraph 1E wherein the first and second separation mediums and the frame are fixedly coupled together.

23E. The separation cartridge of paragraph 1E wherein the frame encloses the first and second separation mediums.

24E. The separation cartridge of paragraph 1E wherein the first separation medium is configured to be received by upper and lower railings in the hood system and the second separation medium is configured to protrude outward from a plane defined by the upper and lower railings.

25E. The separation cartridge of paragraph 24E wherein the separation cartridge is approximately 6.35 centimeters to approximately 19 centimeters wide.

26E. The separation cartridge of paragraph 1E wherein a height of a first portion of a side of the separation cartridge is greater than a height of a second portion of the side of the separation cartridge, the first portion of the side corresponds to a portion of the separation cartridge that comprises the first separation medium and the second portion of the side corresponds to a portion of the separation cartridge that comprises the second separation medium, the first portion of the side being configured to be received by upper and lower railings of a hood.

27E. The separation cartridge of paragraph 1E wherein the first separation medium comprises: a first plate comprising entry openings; and a second plate comprising exit openings, the second plate being spaced apart from the first plate; wherein the entry and exit openings are configured so that it least a portion of the gas stream is deflected as it passes through the openings in the first and second plates.

28E. The separation cartridge of paragraph 27E wherein the space between the first and second plates is approximately 0.3 centimeters to approximately 2.5 centimeters.

29E. A separation cartridge comprising: a separation medium; a packed bed; and a frame configured to hold the separation medium and the packed bed; wherein the separation cartridge is configured to separate an entrained substance from a fluid stream.

30E. The separation cartridge of paragraph 29E wherein the separation medium is a baffle and the fluid stream is a gas stream.

31E. The separation cartridge of paragraph 29E wherein the packed bed comprises inorganic media.

32E. The separation cartridge of paragraph 31E wherein a mean dimension of a particle in the media is approximately 0.1 millimeters to approximately 100 millimeters.

33E. The separation cartridge of paragraph 31E wherein the media includes particles comprising a plurality of sizes.

34E. The separation cartridge of paragraph 31E wherein the inorganic media comprises particles that are substantially solid.

35E. The separation cartridge of paragraph 31E wherein the inorganic media comprises particles that are substantially porous.

36E. The separation cartridge of paragraph 35E wherein the particles comprise an exterior surface and a plurality of channels that open onto the exterior surface and define internal surfaces, the channels having a mean size of approximately 0.01 microns to approximately 10 microns.

37E. The separation cartridge of paragraph 35E wherein the particles are approximately 15% porous to approximately 95% porous.

38E. The separation cartridge of paragraph 37E wherein the particles are approximately 30% porous to approximately 70% porous.

39E. The separation cartridge of paragraph 35E wherein the porous inorganic particles are substantially composed of metals and their oxides.

40E. The separation cartridge of paragraph 29E wherein the packed bed is pleated.

41E. The separation cartridge of paragraph 29E wherein the separation medium separates the entrained substance from the fluid stream primarily by impaction.

42E. The separation cartridge of paragraph 29E wherein the separation medium comprises a mesh filter.

43E. The separation cartridge of paragraph 29E wherein the separation medium and/or packed bed is configured to be easily removed from the separation cartridge.

44E. A separation cartridge comprising: a plurality of separation mediums; and a frame configured to hold the plurality of separation mediums; wherein the separation cartridge is configured to separate an entrained substance from a gas stream.

45E. The separation cartridge of paragraph 44E wherein at least one of the plurality of separation mediums comprises a mesh filter.

46E. The separation cartridge of paragraph 44E wherein at least one of the plurality of separation mediums comprises a baffle.

47E. The separation cartridge of paragraph 44E wherein at least one of the plurality of separation mediums comprises a plurality of perforated plates.

48E. The separation cartridge of paragraph 44E wherein at least one of the plurality of separation mediums comprises a packed bed including inorganic media.

49E. The separation cartridge of paragraph 44E wherein the separation cartridge is configured to be used in conjunction with a hood system.

50E. A separation apparatus comprising: a first plate comprising entry openings; and a second plate comprising exit openings, the second plate being spaced apart from the first plate; wherein the separation apparatus is configured to separate an entrained substance from a gas stream; wherein the entry and exit openings are configured to be offset so that at least a portion of the gas stream passing through the entry openings is deflected before passing through the exit openings.

51E. The separation apparatus of paragraph 50E further comprising: a separation medium positioned adjacent to the first and/or second plates; and a frame configured to hold the separation medium and the first and/or second plates.

52E. The separation apparatus of paragraph 51E wherein the separation medium is a packed bed.

53E. The separation apparatus of paragraph 51E wherein the separation apparatus is configured to be positioned in a hood system.

54E. The separation apparatus of paragraph 50E wherein the first and second plates each comprise an open area of approximately 20% to approximately 60%.

55E. The separation apparatus of paragraph 54E wherein the first and second plates each comprise an open area of approximately 30% to approximately 50%.

56E. The separation apparatus of paragraph 50E wherein one or both the entry openings and exit openings are collared.

57E. The separation apparatus of paragraph 56E wherein the collared openings are tapered.

58E. The separation apparatus of paragraph 56E wherein the plates are configured so that both the entry and exit openings are collared and so that the collared portion of the openings face each other.

59E. The separation apparatus of paragraph 58E wherein the collared portion of the entry openings on the first plate extend past the collared portion of the exit openings on the second plate.

60E. The separation apparatus of paragraph 50E wherein one or both the entry openings and exit openings are louvers.

61E. The separation apparatus of paragraph 50E wherein the entry openings are substantially uniformly positioned on the first plate and the exit openings are substantially uniformly positioned on the second plate.

62E. The separation apparatus of paragraph 50E wherein the entry openings and exit openings are substantially round and/or substantially rectangular.

63E. The separation apparatus of paragraph 50E wherein the offset percentage of the entry openings and exit openings is at least approximately 80%.

64E. The separation apparatus of paragraph 50E wherein the separation apparatus is configured to be included in a system comprising: a hood; ductwork coupled to the hood; and a fan coupled to the ductwork, the fan being configured to move air from the hood through the ductwork; wherein the separation apparatus is coupled to the hood.

65E. A separation apparatus comprising: at least three plates positioned adjacent to one another, each of the plates comprises openings; wherein the plates are configured to separate an entrained substance from a gas stream in a hood system.

66E. The separation apparatus of paragraph 65E further comprising: a separation medium positioned adjacent to at least one of the plates; and a frame that is configured to hold the separation medium and the three plates.

67E. The separation apparatus of paragraph 66E wherein the separation medium is a packed bed.

68E. The separation apparatus of paragraph 65E wherein the plates are configured so that at least a portion of the gas stream is deflected as it passes through the openings in the plates.

69E. The separation apparatus of paragraph 65E wherein the plates comprise openings that are substantially round, substantially louvered, and/or substantially rectangular.

70E. The separation apparatus of paragraph 65E wherein the openings on at least one plate are collared.

71E. The separation apparatus of paragraph 70E wherein the collared openings are tapered.

72E. The separation apparatus of paragraph 70E wherein the plates are configured so that the openings are collared on at least two plates and so that the collared portions of the openings face each other.

73E. The separation apparatus of paragraph 72E wherein the collared portions of the openings on the facing plates extend past each other.

74E. The separation apparatus of paragraph 65E wherein the offset percentage for the combination of all of the plates is not less than approximately 90%.

75E. The separation apparatus of paragraph 65E wherein the open area of each of the plates is approximately 20% to approximately 60%.

76E. The separation apparatus of paragraph 65E wherein the separation apparatus is configured to be included in a separation cartridge.

77E. The separation apparatus of paragraph 65E wherein the entry openings are substantially uniformly positioned on the first plate and the exit openings are substantially uniformly positioned on the second plate.

78E. A separation system comprising: a hood; ductwork coupled to the hood; a fan coupled to the ductwork, the fan being configured to move air including at least one entrained substance from the hood through the ductwork; and a separation cartridge coupled to the hood and/or ductwork, the separation cartridge including: a plurality of separation mediums; and a frame configured to hold the separation mediums.

79E. The separation system of paragraph 78E wherein the separation mediums are capable of being easily removed from the frame.

80E. The separation system of paragraph 78E wherein the separation mediums are selected from a group consisting of a baffle, a packed bed, and a mesh filter.

81E. The separation system of paragraph 78E wherein one of the plurality of separation mediums is a packed bed comprising porous inorganic media.

82E. The separation system of paragraph 78E wherein one of the plurality of separation mediums is a packed bed comprising solid inorganic media.

83E. The separation system of paragraph 78E wherein the separation cartridge is approximately 2.5 centimeters to approximately 19 centimeters wide.

84E. The separation system of paragraph 78E wherein the plurality of separation mediums separate the entrained substances from the air using one or more of the following mechanisms: impaction, absorption, adsorption, and/or sieving.

85E. A separation system comprising: a hood; ductwork coupled to the hood; a fan coupled to the ductwork, the fan being configured to move air from the hood through the ductwork; and a separation apparatus coupled to the hood and/or ductwork, the separation apparatus comprising: a first plate comprising entry openings; and a second plate comprising exit openings, the second plate being spaced apart from the first plate; wherein the entry and exit openings are configured to be at least substantially offset so that at least a substantial portion of the air passing through the entry openings is deflected before passing through the exit openings.

86E. The separation system of paragraph 85E wherein the first and second plates each comprise an open area of approximately 20% to approximately 60%.

87E. The separation system of paragraph 85E wherein the separation cartridge further comprises: a separation medium positioned adjacent to the first and/or second plates; and a frame that is configured to hold the separation medium and the first and/or second plates.

88E. The separation apparatus of paragraph 85E wherein one or both the entry openings and exit openings are collared.

89E. The separation apparatus of paragraph 88E wherein the collared openings are tapered.

90E. The separation apparatus of paragraph 88E wherein the plates are configured so both the entry and exit openings are collared and so that the collared portion of the openings face each other.

91E. The separation apparatus of paragraph 85E wherein the entry openings are substantially uniformly positioned on the first plate and the exit openings are substantially uniformly positioned on the second plate.

92E. A separation cartridge comprising: a first means for separating an entrained substance from a gas stream using a baffle and/or a mesh filter; a second means for separating an entrained substance from a gas stream using a packed bed; and a frame configured to hold the first and second means.

What is claimed is:

1. A ventilation system comprising:
a duct configured to channel exhaust from one location to another location;
a prefilter configured to remove one or more substances from the exhaust; and
a filter including a plurality of porous inorganic particles, the filter being configured to receive the exhaust from the prefilter and remove additional substances from the exhaust.

2. The ventilation system of claim 1, wherein the particles are between about 0.25 mm and 4 mm in size, the porosity of the particles is between 30% to 70%, and the bed depth of the packed bed is about 6.35 mm.

3. The ventilation system of claim 1, wherein the prefilter comprises two plates, each plate comprising a plurality of openings which are louvered and each plate also comprising an open area of about 30% to about 50%.
